(19) United States
(12) Patent Application Publication
(10) Pub. No.: US 2002/0136226 A1
(43) Pub. Date: Sep. 26, 2002

(54) Methods and systems for enabling seamless roaming of mobile devices among wireless networks

(75) Inventors: Thomas W. Christoffel, Concord, MA (US); David N. Juitt, Arlington, MA (US); Geoff Crawshaw, Needham, MA (US); David B. Crosbie, Somerville, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Bluesocket, Inc., Burlington, MA (US)

(21) Appl. No.: 10/055,028

(22) Filed: Jan. 23, 2002

Related U.S. Application Data
(63) Continuation-in-part of application No. 09/911,092, filed on Jul. 23, 2001.
(60) Provisional application No. 60/278,450, filed on Mar. 26, 2001.
(60) Provisional application No. 60/300,531, filed on Jun. 25, 2001.

(51) Int. Cl. H04L 12/28; H04J 1/16

(52) U.S. Cl. 370/401; 370/230

(57) ABSTRACT

A mobile device roams between homogenous or heterogenous wireless networks while maintaining a communication connection with a home network server for the mobile device. A gateway system for a wireless local area network (WLAN) includes gateway servers and manages roaming of a mobile device between homogenous wireless networks. The gateway system maintains a secure connection to a home gateway server for the mobile device while the mobile device roams between homogenous WLAN's. A network gateway manages roaming of a mobile device between heterogenous network systems. The network gateway obtains an access identifier from another heterogenous network system so the mobile device can roam to the other heterogenous network system while maintaining its connection to the home network gateway for the mobile device.

### RELATED APPLICATIONS

This application claims the benefit of U.S. Provisional Application No. 5 60/278,450, filed Mar. 26, 2001, and U.S. Provisional Application No. 60/300,531, filed Jun. 25, 2001. This application is a continuation-in-part of application Ser. No. 09/911,092, filed Jul. 23, 2001. The entire teachings of the above applications are incorporated herein by reference.

### BACKGROUND OF THE INVENTION

Networked desktop computing is typical in both the office and home. Networking of mobile devices, such as mobile telephones, laptop computers, headsets, and PDAs (Personal Digital Assistants), is more difficult. Wireless standards, such as IEEE 802.11 and Bluetooth (BT) are designed to enable these devices to communicate with each other and a wired LAN (Local Area Network). Such mobile devices are capable of transferring between wireless LANs (WLANs), and some mobile devices can transfer between different types of wireless networks (e.g., a WLAN and a cellular mobile telecommunications network). Such transfers typically require establishing a new connection with the new WLAN for the mobile device making the transfer.

These technologies provide for a common attachment approach for different devices, and so enables mobile phones, laptops, headsets, and PDAs to be easily networked in the office and eventually in public locations. The Bluetooth technology is described in the Bluetooth specification, available from Bluetooth SIG, Inc. (see also the www.bluetooth.com web site), the entire teachings of which are herein incorporated by reference. Other standards, such as the IEEE 802.11 (Institute of Electrical & Electronics Engineers) and ETSI (European Telecommunications Standards Institute) HIPERLAN/2, provide a generally similar wireless connection function as Bluetooth and may be used to support WLAN (wireless LAN) communications. See the IEEE 802.11 “Wireless LAN Medium Access Control (MAC) and Physical Layer Specifications,” the entire teachings of which are herein incorporated by reference. See also the ETSI specifications for HIPERLAN/2, such as ETSI document number TR 101 683, “Broadband Radio Access Networks (BRAN); HIPERLAN Type 2; System Overview,” the entire teachings of which are herein incorporated by reference.

The IEEE 802.11 Wireless LAN standard focuses on access points on the same subnet. Security is handled via WEP (Wireless Equivalent Protocol). This sets up an encrypted link (data, not headers) between the mobile device and the access point. If a mobile device decides to associate itself with a new access point on the same subnet then it uses a series of Associate and Disassociate commands defined within the IEEE 802.11 specification to signal its move from the old to the new access point. The new access point then uses its DS (distribution system) layer to route the encrypted data back to the original access point (as 802.3 frames) in order to be encrypted and decrypted. Hence the unencrypted data enters and leaves the original access point irrespective of the actual access point that the mobile is using. This is done because setting up a new encrypted link is a relatively slow process and hence transferring the entire connection to the new access point, so that if the old access point was no longer involved at all, would result in a break in the communication. If a mobile device transfers to a new subnet, a new secure (WEP) session is typically established between the mobile device and the new access point with a new encryption link.

WLAN access points (LAP's) such as those used by 802.11 and Bluetooth are part of an IP subnet; that is, a range of IP addresses that are normally used by all the devices connected to a section of the network delineated by a router (which may also be known as a gateway) that directs packets to and from devices that are outside the subnet.

In one conventional approach, devices (e.g., a router, gateway, or mobile devices) inside the subnet for a WLAN are primarily identified by their MAC address. This is a fixed address tied to the Ethernet card. IP addresses are associated with MAC addresses. There can be multiple IP addresses associated with a single MAC address. Each router or gateway device on the subnet maintains a cache which maps IP addresses within the subnet to the associated MAC addresses. Data packets are sent to the MAC address associated with the IP address by the cache. (For destinations outside the sub-net the data is sent to the router which then forwards them.)

In order for a device (e.g., router or gateway) to find the MAC address associated with a particular IP address, an ARP (address resolution protocol) is used. The device (e.g., router or gateway) follows the ARP and sends out a broadcast message asking for the device associated with the included IP address to respond with its MAC address. Once received it is added to the cache.

For a situation where there are mobile devices attached to an access point then the mobiles MAC address is associated with an IP address from within the subnet IP address space. If the mobile device moves to another access point that is in the same subnet then all that is required is for the new access point to realize that it must respond to the MAC address of the mobile device that has just associated itself, and the previous access point to cease to respond to that MAC address. The MAC to IP address cache does not need to be changed.

If, however, the mobile device moves to an access point connected to another subnet then the original IP address will be unusable. The mobile device would typically be required to obtain a new IP address and so break the previous connection. The user of the mobile device is typically required to re-establish a stateful end-to-end connection such as IPSec (IP Security Protocol, an encryption protocol from the Internet Engineering Task Force (IETF), an organized activity of the Internet Society), and so the user may be required to re-register with the WLAN. For example, the user may be required to re-enter a PIN (personal identification number) or some other password when connecting to a new subnet.

Thus, in order for mobile clients to roam from one subnet to another, one connection (and all its attributes including security) must be dropped and then re-established in the other subnet. In other words, seamless hand-offs can only be done within a subnet and not across different subnets.

Some mobile devices also have the capability of moving among different types of wireless communication networks, such as between a WLAN network (Bluetooth or IEEE 802.11, as described above) and a mobile telecommunications network, such as one based on a mobile telephone communication protocol (e.g., CMTS or cellular mobile telephone system, GSM or Global System for Mobile communications, PCS or Personal Communications Services, or UMTS or Universal Mobile Telecommunications System). For example, the mobile device (e.g., laptop computer or PDA) includes communications interfaces (e.g., communications hardware and software) that allow the mobile device to communicate with two (or more) different types of wireless networks. Typically, when the mobile device moves to access a different type of wireless network, the current communication session with the current wireless network terminates, and the mobile device establishes a new communication session (new communication) with the newly accessed wireless network.

### SUMMARY OF THE INVENTION

To be truly effective, mobile users must be able to move their mobile devices freely from location to location. For example, users must be able to move their mobile devices from the office to their own conference room to the airport lounge to their client's conference room, while maintaining access to the same set of resources without manually registering anew in each location. They should also be able to send and receive messages and voice calls, wherever they are located. Connection servers, such as routers, WLAN gateways, and security servers, should be able to handle a mobile device that moves its connection to the network from access point to access point, from public to private networks, or from one wireless network system to a different type of wireless network system.

Wireless networks, such as two wireless networks that a mobile device roams between, can be characterized as homogenous networks or heterogenous networks, based on whether or not they follow the same (or very similar) wireless communications protocols for communicating with a roaming mobile device. To roam between homogenous networks, the mobile device need have only one wireless communication interface that supports the same wireless communication protocol as used by the homogenous networks. To roam between two heterogenous networks, the mobile device must have two corresponding wireless communications interfaces that support two different wireless communication protocols. By using these two interfaces, the mobile device can communicate over the two heterogenous networks and roam between them.

In conventional approaches, mobile devices have difficulties in roaming among networks in a seamless manner that does not require the termination and establishment of communication session with a home network server for the mobile device when leaving one network and accessing another network.

For homogenous networks, the mobile device typically has difficulties maintaining a secure connection (e.g., WEP based session) that was established in one network when moving to another homogenous network, even if there are no access problems in accessing the other homogenous network. For an IEEE 802.11 based secure wireless connection using WEP, the mobile device must establish a new secure connection when moving to another homogenous network. In addition, a related problem is that IP (Internet Protocol) Layer HI security associations exist only with one server and cannot easily or quickly be transferred. In order to roam between subnets (homogenous networks), a mobile device (client for that server) would have to break down one security association and rebuild it for the new association with another subnet. The approach of the present invention avoids subnets by creating one logical server (a gateway system composed of gateway servers intercommunicating with each other) from a collection of servers.

For heterogenous networks, the mobile device typically has difficulties in accessing a second heterogenous network after roaming from a first heterogeneous network. In traditional approaches the mobile device requires reauthentication that leads to establishing a new connection with the second heterogenous network, and to losing concurrently the previous connection to the first heterogenous network. The present invention describes an approach by which mobile stations can roam between one type of wireless network (e.g., a WLAN) and another (e.g., a cellular network) without having to reauthenticate itself.

Thus, the present invention provides techniques for maintaining connections (such as to a home network server for the mobile device) during a seamless transfer of a mobile device between wireless networks, for both homogenous wireless networks and heterogenous wireless networks.

In one aspect of the present invention related to homogenous networks, the present invention provides a method and gateway system (e.g., two or more gateway servers associated with two or more homogenous wireless networks) for enabling a mobile device to roam among access points in a wireless local area network, the mobile device capable of communicating with the access points. The gateway system includes an initial gateway server for establishing a secure connection (e.g., tunnel) from the mobile device through an initial access point to the initial gateway server, and a target gateway server in communication with the initial gateway server. The initial gateway server provides connection information to the target gateway server about the secure connection, based on a triggering event that initiates a transfer of the mobile device from the initial access point to a target access point associated with the target gateway server. The target gateway server receives the connection information to maintain the secure connection from the mobile device through the target access point back to the initial gateway server.

In another aspect, the mobile device is assigned an internet protocol address by the initial gateway server. The secure connection is based on the internet protocol address and standard authenticating credentials. The initial gateway server maintains the connection based on the internet protocol address assigned to the mobile device.

In a further aspect, the initial gateway server and the target gateway server are coupled by a nested tunnel between the initial gateway server and the target gateway server. The nested tunnel serves to maintain the secure connection from the mobile device back to the initial gateway server.

The nested tunnel between the initial gateway server and the target gateway server, in another aspect, is based on a hard wired connection between the initial gateway server and the target gateway server.

In one aspect, the triggering event is a movement of the mobile device out of range of the initial access point and within range of the target access point.

The triggering event, in another aspect, is a determination that the target access point has a preferable level of congestion compared to a level of congestion for the initial access point.

In a further aspect, the target gateway server extends the secure connection from the target gateway server to the initial gateway server, so that the initial gateway server decrypts secure messages originating from the mobile device.

The target gateway server, in another aspect, establishes a virtual representation of the initial gateway server at the target gateway server.

In another aspect related to heterogenous networks, the present invention provides a method and network gateway (e.g., computer system serving as a gateway to a network system composed of network devices, mobile devices, one or more wireless networks, and communication links) for enabling a mobile device to roam between a first wireless network and a second wireless network. The first wireless network is substantially heterogeneous with the second wireless network. Both the first wireless network and the second wireless network are capable of communicating with an intermediary network. The mobile device is capable of accessing the first wireless network and the second wireless network. The network gateway includes a digital processor coupled with a communications interface. The digital processor hosts and executes a gateway application that configures the digital process to receive a request to access the second wireless network. The gateway application and the mobile device are associated with the first wireless network. The request is on behalf of the mobile device and indicates a network system specifying the second wireless network. For example, the mobile device makes a request to the network gateway through the first wireless network and the communications interface for the mobile device to gain access to the second wireless network (e.g., if the mobile device is moving out of range of the first wireless network and into range of the second wireless network). The gateway application also configures the digital processor to obtain through the communications interface and through the intermediary network an access identifier for the second wireless network and to provide the access identifier to the mobile device to use when accessing the second wireless network.

In another aspect, the first wireless network is a wireless local area network, the second wireless network is a cellular telecommunications network, and the mobile device is a personal digital assistant.

In a further aspect, the request includes a user identification of a user of the mobile device. The gateway application configures the digital processor to determine the identity of the network system as a function of the user identification.

In another aspect, the gateway application configures the digital processor to provide through the communications interface an authentication request based on the request to a dynamic host configuration server.

The access identifier, in one aspect, is an internet protocol address and the intermediary network is the internet.

In a further aspect, the gateway application configures the digital processor to request through the communications interface the access identifier from a second network gateway for the second wireless network. The second network gateway provides the access identifier from a predefined range of access identifiers allocated to the second wireless network.

In another aspect, the gateway application configures the digital processor to store the access identifier in a device database that includes a device identification for the mobile device.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a homogenous network environment including a gateway system according to the present invention.

FIG. 2 is a block diagram of one example of the physical connections for the homogenous network environment of FIG. 1.

FIG. 3 is a flow chart of a procedure for transferring a secure connection for a mobile device from one access point to another access point for FIG. 2.

FIG. 4 is a block diagram of an example of a portion of the homogenous network environment with sample network addresses.

FIG. 5 is a block diagram of a virtual network interface in a gateway server in the gateway system of FIG. 4.

FIG. 6 is a block diagram of a gateway system, multiple gateway servers, and multiple mobile devices, configured according to the present invention.

FIG. 7 is a schematic diagram illustrating an initial IP assignment for a mobile device in a homogenous network environment according to the present invention.

FIG. 8 is a schematic diagram illustrating an authentication request made on behalf of a mobile device in the homogenous network environment 20 of FIG. 7.

FIG. 9 is a schematic diagram illustrating a third-party IP address request made on behalf of the mobile device in the homogenous network environment of FIG. 7.

FIG. 10 is a schematic diagram illustrating an ARP (address resolution protocol) request made on behalf of a mobile device in a homogenous network environment according to the present invention.

FIG. 11 is a schematic diagram illustrating a location update message made on behalf of the mobile device in the homogenous network environment of FIG. 10.

FIG. 12 is a schematic diagram illustrating an information message made on behalf of the mobile device in the homogenous network environment of FIG. 10.

FIG. 13 is a schematic diagram illustrating a nested tunnel for the mobile device in the homogenous network environment of FIG. 10.

FIG. 14 is a block diagram of a heterogenous network environment illustrating a device transfer between two heterogenous network systems according to the present invention.

FIG. 15 is a flow chart of a procedure for providing an access identifier to the mobile device to enable the device transfer of FIG. 14.

FIG. 16 is a schematic diagram illustrating a WLAN gateway and a mobile telephone network gateway in a heterogenous network environment according to the present invention.

FIG. 17 is a schematic diagram illustrating a heterogenous network environment with two heterogenous network systems and a mobile device, according to the present invention.

FIG. 18 is a schematic diagram illustrating a mobile device connected to a cellular network system, according to the present invention.

FIG. 19 is a schematic diagram illustrating an ARP request made on behalf of a mobile device in a heterogenous network environment, according to the present invention.

FIG. 20 is a schematic diagram illustrating an authentication query made on behalf of the mobile device in the heterogenous network environment of FIG. 19.

FIG. 21 is a schematic diagram illustrating an internetwork tunnel for the mobile device in the heterogenous network environment of FIG. 19.

### DETAILED DESCRIPTION OF THE INVENTION

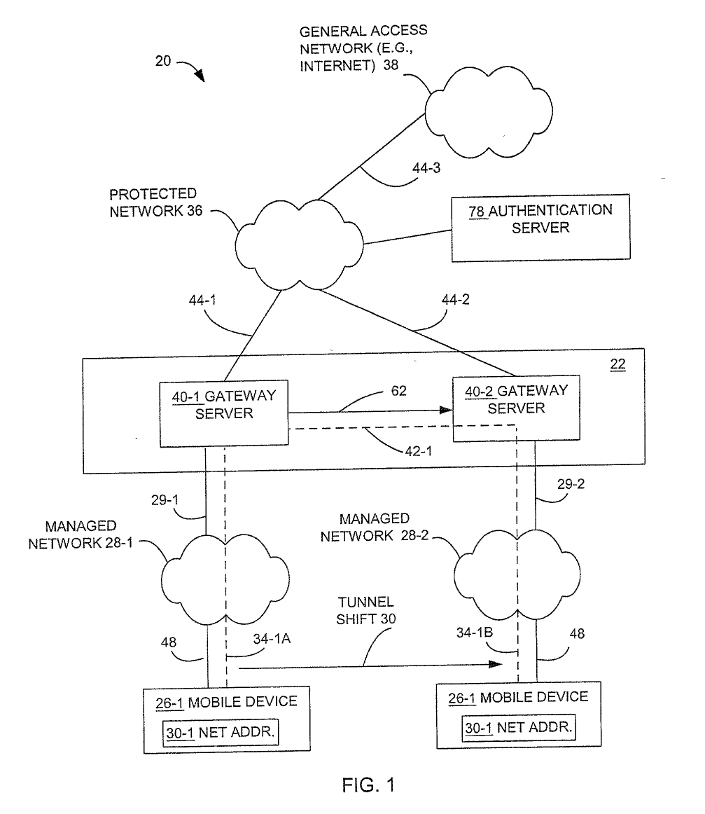

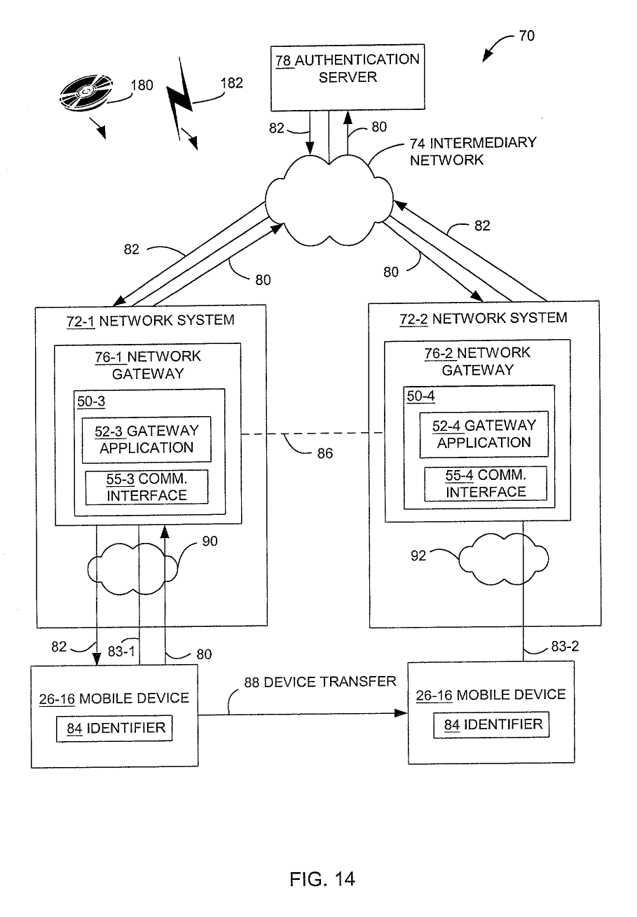

The present invention is directed to techniques for enabling the seamless transfer of mobile devices between wireless communication networks. Such networks may be homogenous, that is, based on the same or similar wireless communication protocols that allow for the transfer of mobile devices between the homogenous wireless networks. FIGS. 1-13 are directed to preferred embodiments of the present invention for the seamless transfer of mobile devices between homogenous networks. Other networks are heterogenous, that is, based on dissimilar wireless communication protocols that do not allow for (or readily allow for) the transfer of mobile devices between the heterogenous networks. FIGS. 14-21 are directed to preferred embodiments of the present invention for the seamless transfer of mobile devices between heterogenous wireless networks.

FIG. 1 is a block diagram of a homogenous network environment 20 including a gateway system 22 that includes two gateway servers 40-1 and 40-2 according to the present invention. The network environment 20 also includes a mobile device 26-1, homogenous managed networks 28-1, 28-2, a protected network 36, and a general access network 38. The protected network 36 connects to the gateway system 22 by network connections 44-1 and 44-2, and the general access network 38 connects to the protected network 36 by network connection 44-3. The gateway system 22 connects to managed networks 28-1, 28-2 by managed network connections 29-1 and 29-2. A mobile device 26-1 connects to the managed network 28-1 by wireless connection 48, and the same mobile device 26-1 connects to the managed network 28-2 by a wireless connection 48. Each mobile device includes a network address 30.

The gateway server 40 (e.g., 40-1 and 40-2) is any suitable computing device or digital processing device that may serve as a network device or server in the networked environment 20. Such a gateway server 40 can be a server, a router, a bridge, a switch or other network communications or computing device (or any combination thereof) that may serve the purpose of a central control or gateway in the networked environment 20. The gateway system 22 is a system of two or more gateway servers 40 that provides communications between a mobile device 26 through a managed network 28 through the gateway system 22 to the protected network 36 and the general access network 38. The gateway servers 40-1, 40-2 in the gateway system 22 communicate with each other, such as through the network connections 44-1, 44-2, which would enable gateway servers, such as gateway servers 40-1 and 40-2, to communicate through the protected network 36. Alternatively, the gateway servers 40-1, 40-2 and the gateway system 22 communicate through direct connections such as hard wired cables through a LAN or other connections, such as wireless connections between the gateway servers 40-1, 40-2.

In a preferred embodiment, the gateway system 22 includes two or more gateway servers 40, and a mobile device 26 can transfer to any gateway server 40 (e.g., 40-2) and transfer among gateway servers 40 in the gateway system 22 while maintaining a connection 42 (e.g., 42-1) to an initial gateway server 40 (e.g., 40-1).

The protected network 36 is a network that is limited by an access control scheme that would prevent, for example, any unauthorized user from accessing the protected network 36. One function of a gateway server 40-1,40-2 in the gateway system 22 is to control access to the protected network 36. For example, the gateway server 40-1 may determine whether the user of a mobile device 26-1 can be authenticated and then authorized to allow access over the network connection 44-1 to the protected network 36 through the gateway server 40-1. The protected network 36, for example, can be an enterprise network, such as a LAN based on an Ethernet or other LAN protocol that is suitable for use in a corporation or other organization. That is, the enterprise network 36 provides services and resources for the individuals in that corporation or other organization. The protected network 36 can also be an internet service provider or ISP as well as a wireless ISP or WISP.

The general access network 38 is a generally available network that is not necessarily protected and that is available to a wide range of users (although specific parts of the general access network 38 may be protected). One example of a general access network 38 is a packet-based general access network based on the IP (Internet Protocol) such as the Internet. The general access network 38 provides resources that may be accessed by the users of mobile devices 26 through the gateway system 22 and protected network 36. For example, a general access network 38 provides web servers and web sites that users of mobile devices 26 may wish to access.

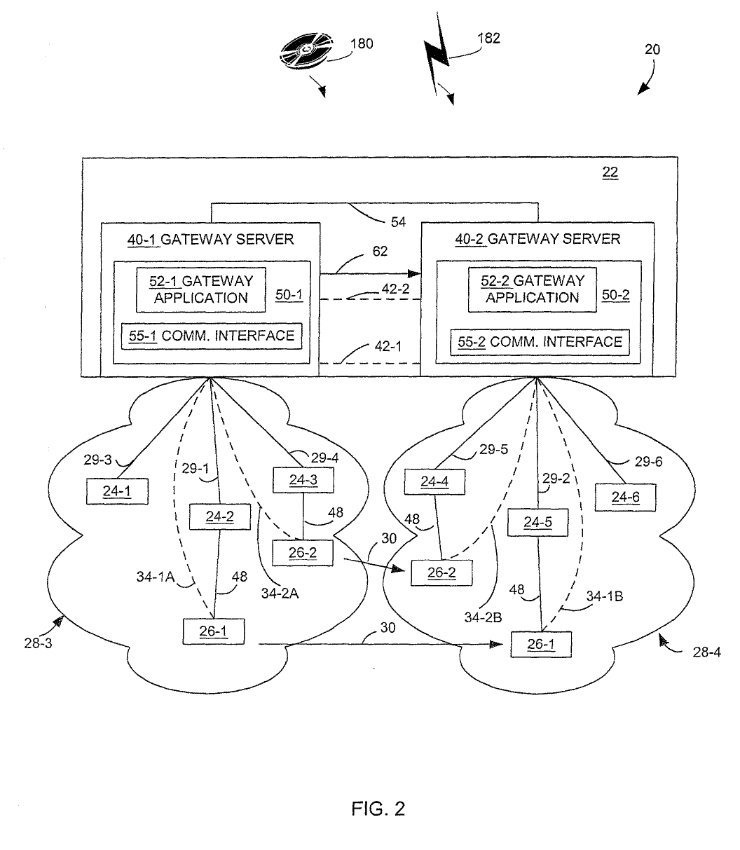

The mobile device 26 (referred to in FIGS. 1-21) is any suitable type of device that will support a wireless technology, such as a wireless connection 48 from the mobile device 26 to the managed network 28. The mobile device 26 may be a computer with a wireless connection adapter, a PDA (personal digital assistant) or a mobile telephone, such as a cellular telephone or other mobile telephone adapted through a managed network 28. The managed network 28 (referred to in FIGS. 1-21) is a homogenous network of network devices managed by the gateway server 40. The managed network 28 provides connections (e.g., 48) to mobile devices 26 and serves as an intermediary between the mobile device 26 and a gateway server 40. The managed networks 28 are homogenous in the sense that they are all based on the same networking protocol (e.g., wireless technology protocols) or similar protocols that readily allow transfers of mobile devices 26. In one example, a managed network 28 includes access points 24 as illustrated in FIG. 2. The present invention does not require that the managed network 28 be composed of access points 24, only that the managed network 28 be composed of any suitable network device, such as a switch, router, access point or gateway that can serve as an intermediary between a mobile device 26 and a gateway server 40.

The wireless connection 48 provides for a connection from the mobile device 26-1 to the managed network 28-1 or 28-2. The wireless connection 48 is any suitable wireless connection based on a wireless technology, such as a Bluetooth technology, an IEEE 802.11 technology, an ETSI HIPERLAN/2 technology, or other wireless technology suitable for use in a WLAN typically providing coverage of 10 to 100 meters. The managed network connections 29-1, 29-2 connects the gateway servers 40-1, 40-2 to the managed networks 28-1 and 28-2. The managed network connection 29 (e.g., 29-1, 29-2) can be any suitable connection for connecting the gateway server 40 to the intermediary devices in the managed network 28. The managed network connection 29 (e.g., 29-1, 29-2) can be a wireless connection or a hard wired cable, such as hard wired cables for an Ethernet LAN.

The mobile device 26-1 also includes a network address 30, which is an address that indicates the network address for the mobile device 26-1. The mobile device 26-1 is connected to the gateway server 40-1 by a tunnel connection 34-1A. In general, the tunnel connection 34 (e.g., 34-1A and 34-1B) is a virtual connection or tunnel through the physical connections 48, 29 to the gateway server 40-1 or 40-2. The tunnel connection 34-1A, 34-1B is referred to herein as “tunnel connection 34-1” to indicate that the tunnel connection 34-1A and 34-1B are the same tunnel from the standpoint of the mobile device 26-1. As shown in FIG. 1, the tunnel 34-1A may be shifted by a tunnel shift 30 to a tunnel connection 34-1B that maintains the same virtual tunnel connection 34-1 for the mobile device 26-1. The tunnel connection 34-1 is based on a secure tunneling protocol such as IPSec (IP Security Protocol) or PPTP (point to point tunneling protocol). Such a secure protocol can be any routing and security protocol that has encryption built in, and thus guarantees the confidentiality and integrity of all of the data transmitted. The connection information 62 is provided by the initial gateway server 40-1 to the target gateway server 40-2 to provide information about a secure connection (e.g., 34-1A).

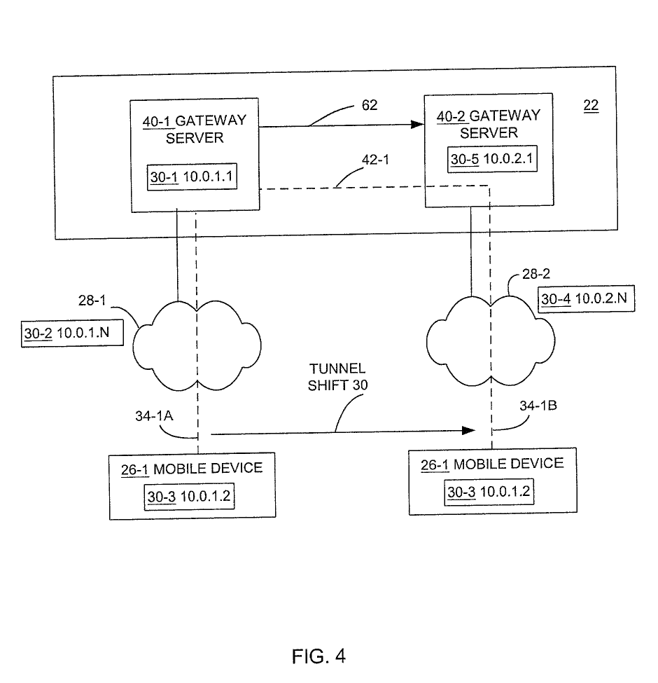

The nested tunnel connection 42 (e.g., 42-1 through 42-5 in FIGS. 1, 2, and 6) continues the tunnel connection 34-1B from the gateway server 40-2 to the gateway server 40-1 so that the mobile device 26-1 operates with the same connection through the tunnel connection 34-1B that the mobile device 26-1 had with the connection 34-1A. For example, the tunnel 34-1B is nested within the tunnel 42-1. The mobile device 26-1 cannot distinguish whether it is communicating with the gateway server 40-1 through the tunnel connection 34-1A or the tunnel connection 34-1B. That is, the transfer of a mobile device 26-1 from gateway server 40-1 through the tunnel shift 30 to gateway server 40-2 is transparent to the mobile device 26-1. Furthermore, the mobile device 26-1 maintains the same network address 30 which is not altered during the tunnel shift 30 (see FIG. 4). That is, the mobile device uses the same network address 30 when communicating through the tunnel connection 34-1A as when communicating through the tunnel connection 34-1B. In one embodiment, the nested tunnel connection 42 is an IP Layer III security tunnel and may be based on a security tunneling protocol such as described for the tunnel connection 34-1. For example, the nested tunnel 42 is a tunnel based on IPsec/PPTP protocols nested within another tunnel based on the SSL (Secure Socket Layer) protocol over the GRE (Generic Routing Encapsulation) protocol.

In one embodiment, an authentication server 78 (a network computing device or network server) provides one or more of the access control functions in coordination with a gateway server 40. For example, the authentication server 78 provides RADIUS (Remote Authentication Dial-in Service), LDAP (Lightweight Directory Access Protocol), and/or Diameter (authentication) protocol services. In a further example, the authentication server 78 can also provide network address services, such as IP (Internet Protocol) addresses and DHCP (Dynamic Host Configuration Protocol) services. In another embodiment, some or all of these services can be provided by one or more of the gateway servers 40-1, 40-2.

FIG. 2 is a block diagram of one example of the physical connections 29, 48, 54 for the homogenous network environment 20 of FIG. 1.

FIG. 2 shows a managed network 28-3 which is one example of the managed network 28-1 of FIG. 1. The managed network 28-3 includes access points 24-1, 24-2, 24-3, connected by managed network connections 29-3, 29-1, 29-4 to the gateway server 40-1. The managed network 28-3 includes wireless connections 48 to mobile devices 26-1 and 26-2.

The managed network 28-4 shown in FIG. 2 is one example of the managed network 28-2 of FIG. 1. The managed network 28-4 includes access points 24-4, 24-5 and 24-6, connected by managed network connections 29-5, 29-2, 29-6 to the gateway server 40-2. The managed network 28-4 also includes wireless connections 48 to mobile devices 26-1 and 26-2 which are transferred from managed network 28-3 to the managed network 28-4 in one example of the mobile device transfer or tunnel shift 30 shown in FIG. 1. One tunnel shift 30 moves the tunnel connection 34-1 by shifting tunnel connection 34-1A to 34-1B for mobile device 26-1. Another tunnel shift 30 moves the tunnel connection 34-2 by shifting tunnel connection 34-2A to 34-2B for mobile device 26-1.

The gateway server 40-1 is connected to the gateway server 40-2 by a gateway intercommunications line 54. The gateway intercommunications line 54 is a wireless or hard wired connection between the gateway servers 40-1 and 40-2. The gateway intercommunications line 54, in one embodiment, is a hard wired cable or dedicated line connecting the gateway server 40-1 to the gateway server 40-2. In another embodiment, the intercommunications line 54 is provided through an Ethernet LAN that provides communications among gateway servers 40 in a gateway system 22. The gateway system 22 may include more than two gateway servers 40 and is not restricted by the present invention in the number of gateway servers 40, that may be included in a gateway system 22. In another embodiment, the intercommunications line 54 is provided by connections through a network such as the connections 44-1 and 44-2 through the protected network 36 shown in FIG. 1. In one embodiment, the intercommunications line 54 serves as the physical link (hard wired or wireless) between the gateway server 40-1 and 40-2 that provides the underlying physical link or physical communications for the virtual nested tunnel 42 (e.g., 42-1 or 42-2). Thus, the virtual nested tunnel 42 serves as an abstraction layer or virtual layer of communications between the gateway server 40-1 and gateway server 40-2, while the intercommunications line 54 serves as the lower level or physical connection between the gateway servers 40-1 and 40-2. In another embodiment, the virtual nested tunnel 42 is a virtual connection between the gateway servers 40-1 and 40-2 based on communications over a network, for example, over an IP network using an Internet tunneling protocol such as GRE.

The access point 24 (e.g., 24-1 through 24-6) is a network communication device capable of handling the wireless connections 48 from mobile devices 26-1 and 26-2 based on a wireless technology. The access points 24 (e.g., 24-1 through 24-6) act as a receiving points or connecting points to establish the wireless connections 48 with the mobile devices 26-1 and 26-2.

The gateway server 40-1 includes a digital processor 50-1 and the gateway server 40-2 includes a digital processor 50-2. The digital processor 50 (e.g., 50-1 and 50-2) is a digital processing chip or device such as a microprocessor, suitable for use in a digital processing system or computer. Each digital processor, 50-1 or 50-2, hosts and executes a preferred embodiment of a gateway application 52-1 or 52-2 that manages the communications with mobile devices 26-1 and 26-2 through managed networks 28-3 and 28-4. Each gateway application 52-1 or 52-2 serves as a gateway between the mobile device 26-1 or 26-2 and other resources such as a protected network 36 or general access network 38, that the mobile device 26-1 or 26-2 is trying to access. Each gateway application 52-1 and 52-2 provides access control (e.g., authentication and authorization) for the mobile devices 26-1 and 26-2 that are communicating through the gateway system 22. When the gateway server 40 is referred to herein as performing some function, this means that the digital processor 50-1, 50-2 of the gateway server 40-1, 40-2 is performing that function based on the instructions of the gateway application 52-1, 52-2 that is hosted and executing on the digital processor 50-1, 50-2.

The gateway server 40 also includes a communications interface (e.g., 55-1, 55-2) that includes hardware and software that provides communications over network or other connections (wireless or hard wired) (e.g., intercommunications line 54, network connection 29, or network connection 44) to other entities (e.g., mobile devices 26, gateway servers 40, or one or more authentication servers 78).

In one embodiment, a computer program product 180, including a computer readable or usable medium (e.g., one or more CDROMs, diskettes, tapes, etc.), provides software instructions for the gateway application 52 (e.g., 52-1 and 52-2 in FIG. 2, and 52-3 and 52-4 in FIG. 14). The computer program product 180 may be installed by any suitable software installation procedure, as is well known in the art. In another embodiment, the software instructions may also be downloaded over a wireless connection. A computer program propagated signal product 182 embodied on a propagated signal on a propagation medium (e.g., a radio wave, an infrared wave, a laser wave, a sound wave, or an electrical wave propagated over the Internet or other network) provides software instructions for the gateway application 52. In alternate embodiments, the propagated signal is an analog carrier wave or digital signal carried on the propagated medium. For example, the propagated signal may be a digitized signal propagated over the Internet or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 180 is a propagation medium that the computer may receive and read, such as by receiving the propagation medium and identifying a propagated signal embodied in the propagation medium, as described above for the computer program propagated signal product 182.

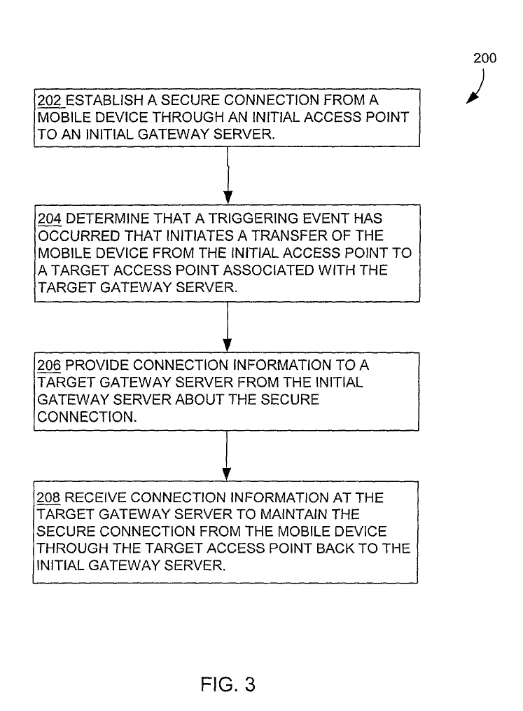

FIG. 3 is a flow chart of a procedure 200 for transferring a secure connection (e.g., 34-1) for a mobile device 26 from one access point 24 to another access point 24. In step 202, an initial gateway server 40 establishes a secure connection from a mobile device 26 through an initial access point 24 to the initial gateway server 40. For example, the mobile device 26-1 (FIG. 2) and the gateway server 40-1 establish a tunnel connection 34-1A that connects the mobile device 26-1 through an initial access point 24-2 to the gateway server 40-1, thus establishing a secure connection based on the tunnel connection 34-1A.

In step 204, the initial gateway server 40 determines that a triggering event has occurred and initiates a transfer of the mobile device 26 from the initial access point 24 to a target access point 24 associated with the target gateway server 40.

In one embodiment, gateway application 52 of gateway server 40 detects a triggering event that initiates a transfer of the mobile device 26 from the initial gateway server 40 to another (target) gateway server 40. This transfer is indicated by a tunnel shift 30 as in FIG. 1. Such a triggering event can be the moving of the mobile device 26 (e.g., when the user moves the mobile device 26 from one location to another), or receiving a request from a mobile device 26 or gateway server 40 to move the mobile device 26. For example, the gateway server 40-1 (or an access point 24) initiates the transfer of the mobile device 26-1 from the initial access point 24-2 (FIG. 2) in managed network 28-3 to the access point 24-5 in managed network 28-4.

For example, the triggering event occurs when the mobile device 26-1 is moved by the user from one location to another so that the mobile device 26-1 is moving out of range of the managed network 28-3 of the gateway server 40-1 and into range of the managed network 28-4 of the gateway server 40-2. The triggering event can also be indicated by congestion or the need for load balancing for the managed network 28-3. For example, the managed network 28-3 may become congested in comparison to transferring the tunnel connection 34-1A to tunnel connection 34-1B (e.g., so that the mobile device 26-1 can be moved to another managed network 28-3 to obtain a higher level of service, such as more bandwidth). The triggering or initiating event can also be receiving an indication of the quality of service level assigned to the user of the mobile device 26-1 (e.g., moving the mobile device 26-1 to a new managed network 28-4 to fulfill a predefined service level for the user of the mobile device 26-1). Furthermore, the triggering event can also be an indication of a poor or declining quality of the connection 48 (e.g., radio link) between a mobile device 26-1 and an access point 24-2 (e.g., resulting in a transfer of the mobile device 26-1 from one access point 24-2 to another access point 24-5, as shown in FIG. 2, that provides an improved quality of service for the mobile device 26-1 over the connection 48 from mobile device 26-1 to gateway server 40-2).

A triggering event is indicated, in one example, by a weakening reception of the wireless signal from the mobile device 26-1 as indicated by increased packet loss on the link 48 to that particular mobile device 26-1, and/or by another indication of weakening reception, such as RSSI (Received Signal Strength Indication).

In step 206, the initial gateway server 40 provides connection information 62 to the target gateway server 40 about the secure connection that was established in step 202. The initial gateway server 40 may provide this connection information 62 or registry connection information 62 with the gateway server 40 prior to or after step 204. For example, in the gateway system 22 the gateway servers 40-1, 40-2 may register connection information 62 with each other about the mobile devices 26-1, 26-2 that they are aware of and that are connected to through managed networks 28-3, 28-4, without waiting for a triggering effect to occur. The initial gateway server 40-1 may provide connection information 62 related to the mobile device 26-1 such as the network address 30, and may or may not provide security information such as encryption information that maybe required to decrypt communications from the mobile device 26-1 that are sent to the gateway server 40-1 over the tunnel connection 34-1A.

In step 208, the target gateway server 40 receives the connection information 62 at the target gateway server 40 to maintain the secure connection (e.g., 34-1) from the mobile device through the target access point 24 and through the target gateway server 40 back to the initial gateway server 40. As shown in FIG. 2, the connection 34-1 is maintained through a tunnel connection 34-1B from a mobile device 26-1 to the target gateway server 40-2 and through the nested tunnel connection 42-1 to the initial gateway server 40-1. Through these connections 34-1B and 42-1, the mobile device 26-1 may communicate in a secure manner with the initial gateway server 40-1 and in a manner that is transparent to the mobile device 26-1. In one embodiment, each transferred tunnel 34-1B and 34-2B has its own nested tunnel connection 42-1 and 42-2, respectively, from target gateway server 40-2 to initial gateway server 40-1.

In a traditional transfer of a mobile device 26 between different subnets, typically, a new secure connection (e.g., WEP or Wireless Equivalent Protocol session) is established. The problem of maintaining the WEP sessions when mobile devices 26 move between access points 24 on different subnets (e.g., managed networks 28) is solved in the present invention by moving the encryption and decryption from the access point 24 to the gateway server 40. Hence a mobile device 26 moving between access points 24 controlled by one gateway server 40 does not require any change in the connection. When a mobile device 26 moves from the coverage area of one gateway server 40 to another, then the encrypted traffic is naturally routed back to the original gateway server 40 for decryption through a tunnel connection 34 and nested tunnel 42, hence there is no break in the encryption path.

Using the approach of the present invention, as described in FIG. 3, portability is enhanced since hand-offs of mobile devices 26 can be done within any address space. Roaming complexity is reduced from roaming between access points 24 to roaming between gateway servers 40. Routing is simplified, since the address of a mobile client (mobile device 26) remains fixed once it joins the network environment 20. Since the backbone (e.g., gateway system 22) can be wired, there can be significant physical separation between servers 40. For this reason, the architecture of the present invention can be scaled to provide geographically dispersed entities with the look and feel of a local area network. Furthermore, access points 24 can be dumb and therefore inexpensive; they are essentially reduced to transparent wireless-to-Ethernet bridges. In one embodiment, this creates the opportunity for cost-effective picocell network architectures. The wireless environment is managed as a single network entity through one gateway system 22 that manages multiple managed networks 28.

FIG. 4 is a block diagram of an example of a portion of the homogenous networked environment 20 of FIG. 1 with sample network addresses 30 (e.g., IP addresses). In addition to what is shown in FIG. 1, in FIG. 4 the gateway server 40-1 has an assigned network address 30-1 with a value of 10.0.1.1, and the gateway server 40-2 has an assigned network address 30-5 with a value of 10.0.2.1. The managed network 28-1 has an assigned network address of 10.0.1.N, and the managed network 28-2 has an assigned network address of 10.0.2.N. The mobile device 26 has an assigned network address 30-3 with a value of 10.0.1.2.

In a conventional approach using a traditional wireless technology, the transfer of the mobile device 26-1 indicated by the tunnel shift 30 is likely to fail because the mobile device 26-1 has a network address, 10.0.1.2, indicating a subnet value (“1” in the third position in the address) that is not compatible with the subnet value (“2” in the third position) of the network address, 10.0.2.N, of the managed network 28-2 being transferred to. In a traditional approach, the mobile device 26-1 is typically required to change its network address 30-3 in order to attach to the new managed network 28-2. However, because the mobile device 26-1 has a new network address 30 in the traditional approach, then the existing tunnel connection 34-1A would be broken down and the mobile device 26-1 would be required to establish a new connection 34 with the gateway server 40-2 (including new security information).

With the tunneling approach of the present invention, the mobile device 26-1 transfers to the managed network 28-2 while maintaining the same tunnel connection 34-1B (and can maintain existing security information that is transferred in the connection information 62), because the gateway server 40-2 and gateway server 40-1 establish a nested tunnel connection 42-1 that extends the tunnel connection 34-1B back to the initial gateway server 40-1 (see FIG. 4).

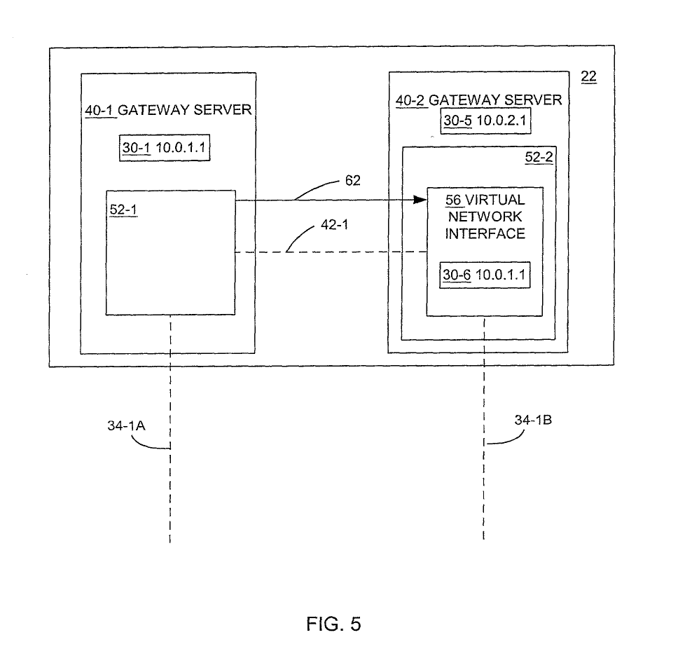

FIG. 5 is a block diagram of a virtual network interface 56 in a gateway server 40-2 in the gateway system 22 of FIG. 4. The virtual network interface 56 has a network address 30-6 with the same value as the network address 30-1 of the gateway server 40-1. The virtual network interface 56 is part of the gateway application 52-2 of the gateway server 40-2 and functions to provide an interface for the gateway end of the tunnel connection 34-1B (originating from the mobile device 26-1). The virtual network interface 56 is a virtual representation of the gateway server 40-1 at the gateway server 40-2 based on connection information 62 transferred from the gateway application 52-1. Thus, the virtual network interface 56 provides an interface at the gateway server 40-2 for the tunnel connection 34-1B that is identical to the interface at the gateway server 40-1 for the tunnel connection 34-1A. Thus, when the tunnel shift 30 occurs for mobile device 26-1, the mobile device 26-1 is able to maintain the same tunnel connection 34-1 that connected to gateway server 40-1 as tunnel connection 34-1 A that now connects as tunnel connection 34-1B to the virtual network interface 56 of gateway server 40-2. The mobile device 26-1 communicates with tunnel connection 34-1B after the tunnel shift 30 in a similar manner as communications using the tunnel connection 34-1A before the tunnel shift 30, without any breaking down or interruption of the tunnel connection 34-1. That is, during the tunnel shift 30, there is no significant interruption of packet communications through tunnel 34-1B and nested tunnel 42-1 between the gateway server 40-1 and the mobile device 26-1. In other words, any interruption of packet communications that do occur during the tunnel shift 30 is within the parameters of the communications protocol for an acceptable delay or interruption in the transmission of packets (between the mobile device 26-1 and the gateway server 40-1) that does not require a breaking down and re-establishment of the tunnel connection 34-1.

The virtual network interface 56 receives communications from the mobile device 26-1 through the tunnel connection 34-1B and sends the communications through the nested tunnel 42-1 to the gateway application 52-1 of the gateway server 40-1. The virtual network interface 56 also handles communications from the gateway application 52-1 of the gateway server 40-1 intended for the mobile device 26-1. The virtual network interface 56 receives these communications through the nested tunnel 42-1 and transfers them through the tunnel connection 34-1B to the mobile device 26-1. The mobile device 26-1 thus receives the communications from the gateway server 40-1 in a transparent manner over the tunnel connection 34-1B, as though the mobile device 26-1 was receiving the communications over the tunnel connection 34-1A.

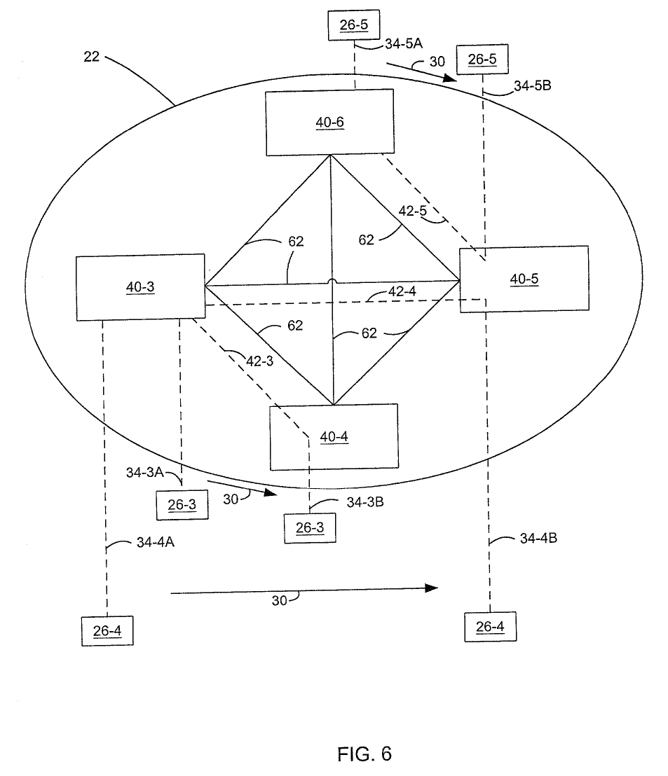

FIG. 6 is a block diagram of a gateway system 22, multiple gateway servers, 40-3, 40-4, 40-5, 40-6 and multiple mobile devices 26-3, 26-4, 26-5, 26-6, configured according to the present invention. Mobile device 26-3 has a tunnel connection 34-3A to initial gateway server 40-3, and the mobile device 26-3 transfers to target gateway server 40-4 using a tunnel shift 30 from tunnel connection 34-3A to a new tunnel connection 34-3B from mobile device 26-3 to target gateway server 40-4, with communications back to the initial gateway server 40-3 through the nested tunnel 42-3. Mobile device 26-4 has a tunnel connection 34-4A to initial gateway server 40-3, and mobile device 26-4 transfers to target gateway server 40-5 using a tunnel shift 30 to a new tunnel connection 34-4B from mobile device 26-4 to target gateway server 40-5, with communications back to the initial gateway server 40-3 through the nested tunnel 42-4. Mobile device 26-5 has a tunnel connection 34-SA to initial gateway server 40-6, and mobile device 26-5 transfers to target gateway server 40-5 using a tunnel shift 30 to tunnel connection 34-5B from mobile device 26-5 to target gateway server 40-5, with communications back to the initial gateway server 40-6 through the nested tunnel 42-5.

The gateway servers 40-3, 40-4, 40-5, 40-6 communicate connection information 62 about the connections to mobile devices 26-3, 26-4, 26-5 for each gateway server 403, 40-4, 40-5, 40-6. In one embodiment, the gateway servers 40-3, 40-4, 40-5, 40-6 communication connection information 62 about a mobile device 26-3, 26-4, 26-5 as the result of a triggering event that indicates that a mobile device 26-3, 26-4, or 26-5 is transferring to another gateway server 40-3, 40-4, 40-5, or 40-6. For example, mobile device 26-3 is moving out of range of gateway server 40-3 (i.e., out of range of any access points 24 connected to gateway server 40-3 in a managed network 28). Thus the gateway server 40-3 sends connection information 62 about the tunnel connection 34-3A to gateway server 40-4 (if the gateway server 40-3 knows that the transfer is to gateway server 40-4) or distributes (e.g., broadcasts) the connection information 62 throughout the gateway system 22 to all of the other gateway servers 40-4, 40-5, and 40-6. In another embodiment, each gateway server 40-3, 40-4, 40-5, or 40-6 distributes (registers) the connection information 62 to the other gateway servers 40-3, 40-4, 40-5, 40-6 whenever a mobile device 26-3, 26-4, or 26-5 connects to one of the gateway servers 40-3, 40-4, 40-5, or 40-6. For example, if mobile device 26-5 establishes a tunnel connection 34-5A with gateway server 40-6, then that gateway server 40-6 distributes connection information 62 about the tunnel connection 34-5A and the mobile device 26-5 to the other gateway servers 40-4, 40-5, and 40-3 to register the mobile device 26-5 with those gateway servers 40-4, 40-5, and 40-3.

In another embodiment, one gateway server 40 serves as a registry of connection information 62 for each mobile device 26 that is connected to or associated with the gateway system 22. In a further embodiment, connection information 62 is stored in a data server or registry server available to, but outside of, the gateway system 22.

In one embodiment, the gateway servers 40 in FIG. 6 are connected by a backbone (e.g., connections such as gateway intercommunications line 54) that could be wireless or wireline (hard wired). In one embodiment, the backbone is based on a hard wired LAN, such as an Ethernet, connecting the gateway servers 40 (e.g., 40-3, 40-4, 40-5, and 40-6). FIG. 6 shows four gateway servers 40, but the number that could be accommodated in a gateway system 22 that is much larger than this, limited in general by the address structure of the enterprise. Each gateway server 40 has its own pool of addresses 30 with values such as: 10.0.1.0, 10.0.2.0, etc. Once an address 30 is assigned to a mobile device 26, the address 30 stays with the mobile device 26 as it moves from one access point 24 to another access point 24 managed in managed networks 28 by the gateway system 22. The maximum number of available network addresses 30 can be accommodated in this way.

The present invention does not require the mobile device 26 to transfer to any particular gateway server 40, and, generally, the mobile device 26 can transfer from one gateway server 40 to another gateway server 40 while maintaining a connection 42 back to the same initial gateway server 40. For example, the mobile device 26-3 could transfer to one target gateway server 40 (e.g., 40-4) and then to another target server 40 (e.g., 40-5, or 40-6) and still maintain a connection 42 to the initial gateway server 40-3.

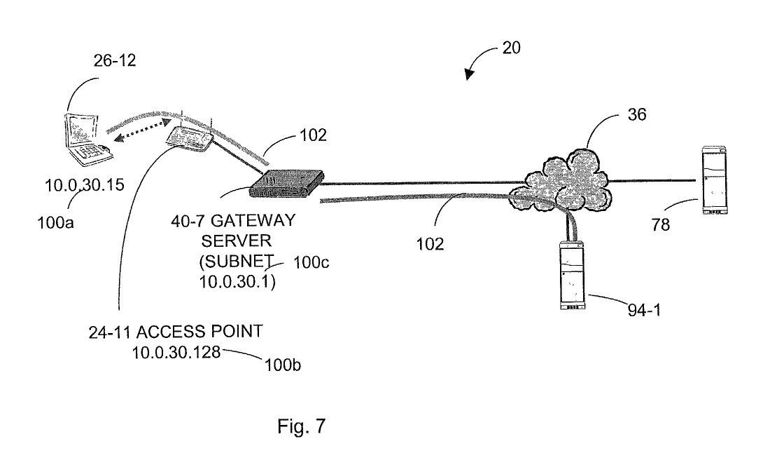

FIGS. 7 through 13 illustrate an example of stages in the IP address assignment process for a mobile device 26-12 transferring between homogenous WLAN networks for a preferred embodiment of the invention.

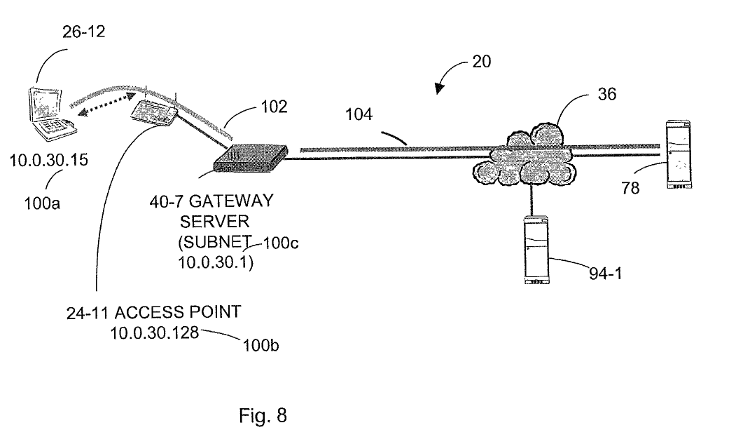

FIG. 7 is a schematic diagram illustrating an initial IP assignment for mobile device 26-12 in a homogenous network environment 20 according to the present invention. The mobile device 26-12 associates with the access point 24-11 that has an IP address 100b with a value of 10.0.30.128. The IP address 100b is one example of a network address 30. Before the user authentication is completed (see FIG. 8) mobile device 26-12 makes an IP address (DHCP) request 102 for an IP address 100 to the gateway server 40-7 in order to receive the initial IP address assignment 100 for the mobile device 26-12.

The IP address request 102 is answered by the gateway server 40-7 in one of two approaches. The first approach is an answer from the gateway server 40-7 itself (through internal DHCP functionality within the gateway server 40-7) with an IP address 100 for the mobile device 26-12 and an IP address 100c for a gateway (e.g., gateway server 40-7 or some other gateway server 40, if one is available) appropriate to that sub-net. The second approach is an answer from a MAC address driven IP server 94-1 (e.g., DHCP server) that issues and returns an IP address 100a (e.g., 10.0.30.15) for use by the mobile device 26-12.

In both cases the DHCP “time to live” for the IP address is set very short so that, if necessary, this address 100a (e.g., 10.0.30.15) for the mobile device 26-12 can be changed immediately after the user authentication (see FIG. 8).

FIG. 8 is a schematic diagram illustrating an authentication request 104 for the mobile device 26-12 in the homogenous network environment 20 of FIG. 7. The gateway server 40-7 redirects all HTTP (Hypertext Transfer Protocol) requests so the user is presented with a secure web page (e.g., displayed by the mobile device 26-12) through which the user enters a name and password. The gateway server 40-7 then authenticates the user against an authentication server 78 (e.g., RADIUS/LDAP server). The authentication server 78 then returns “role” (e.g., user's role in an organization) and “domain” (e.g., network system 72, see FIG. 14).

The role indicates the role of the user of the mobile device 26-12, for example, “Executive” for a user who is a manager or an executive in an organization, “Admin” for a worker with an administrative function, “Visitor” for someone visiting the organization or site. Depending on the user's role, each user (or a group of users) has a different level of access to (or different set of privileges for) resources that are available to the mobile device 26-12, such as through the protected network 36.

The domain tells the gateway server 40-7 which network grouping (e.g., network system 72, see FIG. 14) the mobile device 26-12 “belongs to”. So, for example, if the user is in fact an employee from the United Kingdom visiting the United States office of an company or organization, then it may be most appropriate to give the user an IP address 100 from the range (of IP addresses) reserved for the U.K., even though the user is actually connected to a U.S. subnet.

In order to switch IP addresses 100 (if required) after the authentication process, the gateway server 40-7 waits until the mobile device 26-12 asks to renew its DHCP lease. The gateway server 40-7 then obtains a new IP address 100 that has a much longer time to live and replies to the mobile device 26-12 with the new IP address 100.

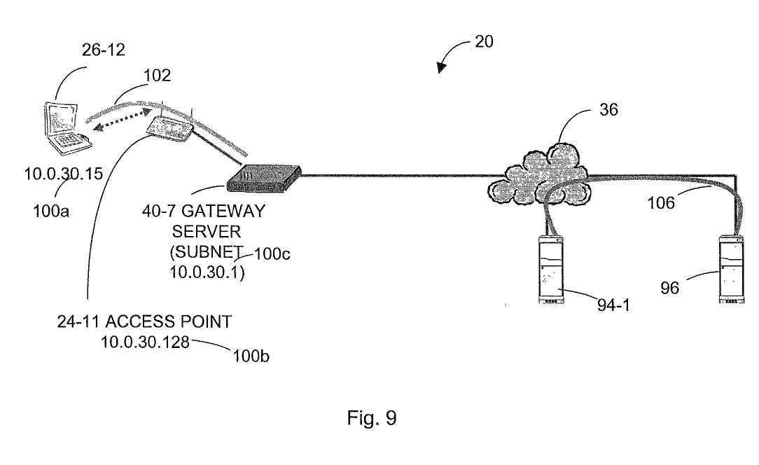

FIG. 9 is a schematic diagram illustrating a third-party IP address request 106 for the mobile device 26-12 in the homogenous network environment 20 of FIG. 7. In some cases, the gateway server 40-7 may also interconnect with third party public or semi-public access providers (e.g., WISP or Wireless Internet Service Providers). The gateway server 40-7 (as well as authenticating users against a third party authentication server 78) may also obtain the IP address 100 from the third party remote IP address (e.g., DHCP) server 96 as well.

As described above, the domain (e.g., network system 72) received from the authentication server 78 tells the gateway server 40-7 which network group the mobile device 26-12 “belongs to”. So, for example, if the user is a customer of a GPRS cellular operator who is temporarily using a WISP, then the domain would be the network system 72 (see FIG. 14) of the cellular operator. In such a case the user needs an IP address 100 from the cellular operator's address space. In this case, the domain represents, for example, a network system 72-1 that provides an access identifier 84 (e.g., EP address) for use when accessing a wireless network 92 associated with the network system 72-1 (see FIG. 14).

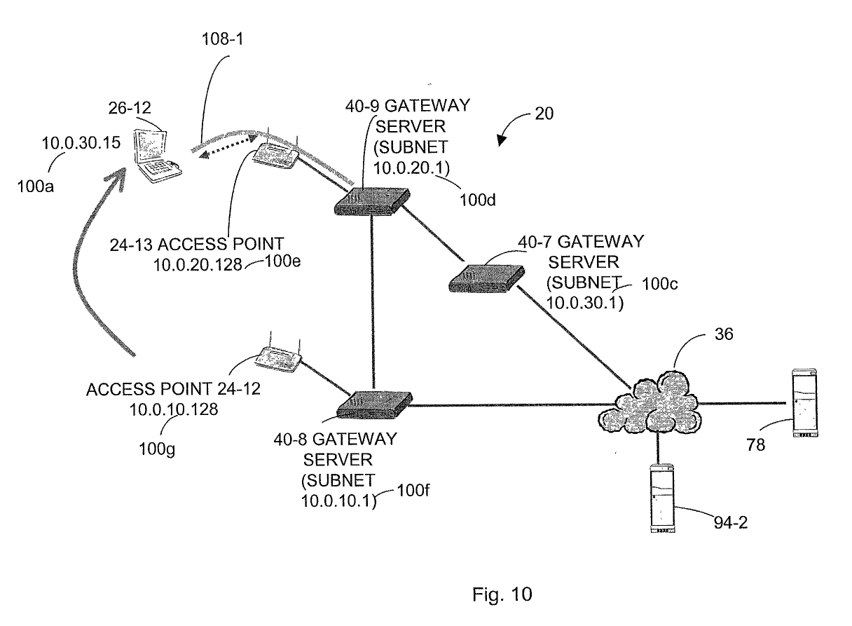

FIG. 10 is a schematic diagram illustrating an ARP (address resolution protocol) request 108-1 for a mobile device 26-12 in a homogenous network environment 20 according to the present invention. The network environment 20 includes gateway servers 40-7, 40-8, 40-9, access points 24-12, 24-13, mobile device 26-12, protected network 36 (alternatively network 38), token driven IP address server 94-2 (e.g., DHCP server), and authentication server 78.

After receiving the IP address 100a (as described for FIG. 7 through FIG. 9), suppose that the mobile device 26-12 associates with access point 24-12 (or is assigned access point 24-12 by the home gateway server 40-7 for the mobile device 26-12). The mobile device 26-12 thus communicates with gateway server 40-8 rather than directly to the home gateway server 40-7. (The mobile device 26-12 can still communicate through this server 40-8 to the home gateway server 40-7.) In one embodiment, the gateway server 40-8 uses a virtual network interface 56 (see FIG. 5) that uses the network address 100c (10.0.30.1) of the home gateway server 40-7 to enable the mobile device 26-12 to associate with the access point 24-12 and the gateway server 40-8.

Suppose that the mobile device 26-12 leaves the coverage area of the gateway server 40-8 (and the home gateway server 40-7). Thus, the mobile device 26-12 moves from the coverage area of access point 24-12 to the coverage area of the access point 24-13, which is associated with the gateway server 40-9.

The mobile device 26-12 tries to associate with access point 24-13. The mobile device 26-12 sends data packets to the MAC address of the gateway server 40-8 that the mobile device 26-12 has been previously using. There is no reply from the gateway server 40-8, so the mobile device 26-12 makes an ARP broadcast request 108-1 with the IP address 100f having a value of 10.0.10.1 (which is the address of the gateway server 40-8 that it was using previously).

The gateway server 40-9 on the local subnet responds to the ARP request 108-1 with the MAC address of the gateway server 40-9, so the gateway server 40-9 becomes the gateway for the mobile device 26-12. In one embodiment, the gateway server 40-9 uses a virtual network interface 56 (see FIG. 5) that uses the network address 100c (10.0.30.1) of the home gateway server 40-7 to enable the mobile device 26-12 to associate with the access point 24-13 and the gateway server 40-9.

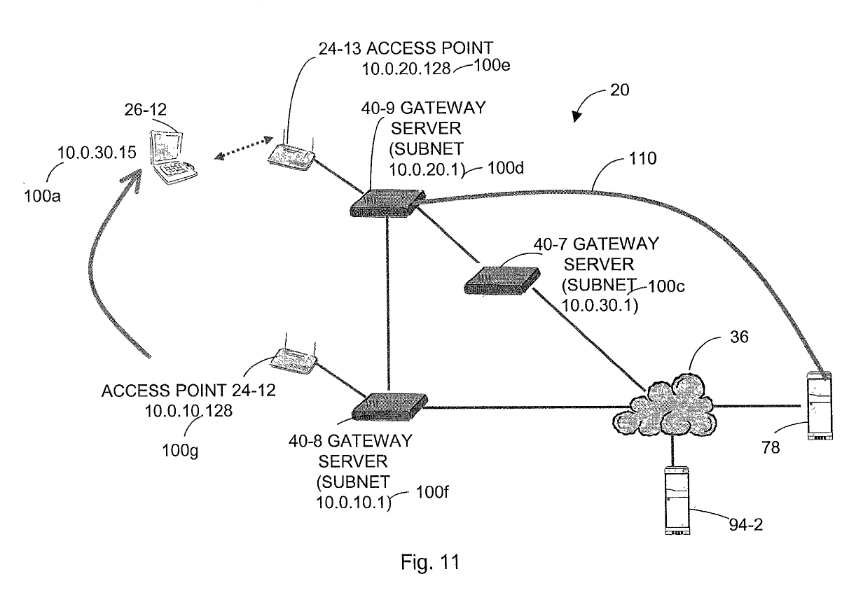

FIG. 11 is a schematic diagram illustrating a location update message 110 for the mobile device 26-12 in the homogenous network environment 20 of FIG. 10. Each time the gateway server 40-9 receives either an ARP request 108-1 or a packet from a new mobile device 26, then the gateway server 40-9 sends the location update message 110 to the authentication server 78 server to inform the authentication server 78 of the new location of the mobile device 26-12. The authentication server 78 server then returns the IP address 100c (e.g., 10.0.30.1) of the home gateway server 40-7 for the mobile device 26-12.

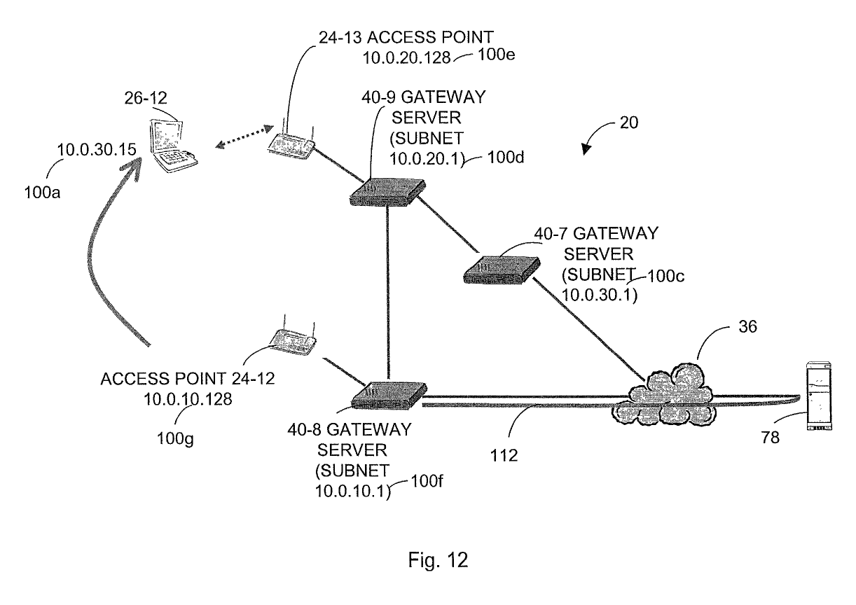

FIG. 12 is a schematic diagram illustrating an information message 112 for the mobile device 26-12 in the homogenous network environment 20 of FIG. 10. The information message 112 invalidates the previous route (e.g., communication route or tunnel from the mobile device 26-12 to the gateway server 40-8 that the mobile device 26-12 was previously attached to). The authentication server 78 sends the information message 112 to the gateway server 40-8 informing the gateway server 40-8 of the move of the mobile device 26-12 to its current association with gateway server 40-9.

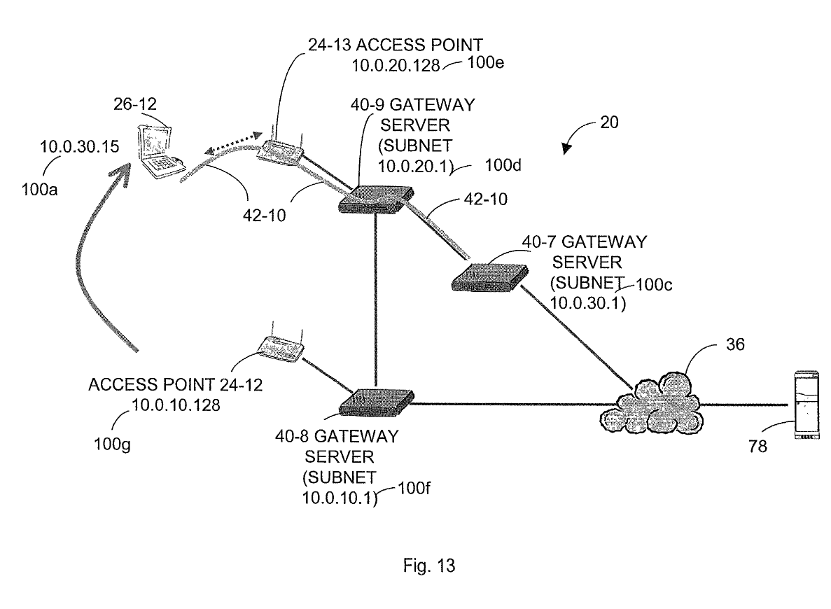

FIG. 13 is a schematic diagram illustrating a nested tunnel 42-10 for the mobile device 26-12 in the homogenous network environment 20 of FIG. 10. The gateway server 40-9 receives the IP address 100c of the home gateway server 40-7 for the mobile device 26-12 and sets up a nested tunnel 42-10 back to the home gateway server 40-7. The home gateway server 40-7 now knows (due to the update message 110, FIG. 11) the network location of the mobile device 26-12 and so can forward packets for the mobile device 26-12 received through the protected network 36 to the mobile device 26-12 through the gateway server 40-9.

FIG. 14 is a block diagram of a heterogenous network environment 70 illustrating a device transfer 88 between two heterogenous network systems 72-1, 72-2, according to the present invention. The heterogenous network environment 70 further includes an authentication server 78, an intermediary network 74, wireless networks 90, 92, and a mobile device 26-16.

The network system 72 (e.g., 72-1, 72-2) is a system of networked devices (e.g., mobile telephones, PDA's, laptop computers, personal computers, server computers, access points, routers, bridges, and/or gateways) in communication with each other using a communications protocol. Beyond the wireless communications protocol used for communicating with one or more mobile devices 26, each network system 72 generally may include one or more networking protocols, networking standards, and/or wireless technologies that provide communications within the network system 72. When used to associate mobile devices 26 with a network system 72-1, 72-2, the wireless communications protocols are heterogenous because the protocol is the same within each network system 72-1 or 72-2, but different (heterogenous) relative to or across the other network system 72-1 or 72-2. For example, a network system 72-1 is a WLAN that includes mobile devices 26, access points 24, and gateway servers 40. The network system 72-1 is based on a Bluetooth, IEEE 802.11 wireless technology, or other wireless communication technology suitable for communicating with the mobile device 26-16. However, in addition, the network system 72-1 can also use a hard-wired LAN (e.g., cable based Ethernet) for communications between the access points 24 and the network gateway 76-1. In a particular example, a network system 72 for a WLAN is based on the gateway system 22 of FIG. 1. In another example, a network system 72 is a mobile telephone system, such as a cellular phone system that uses mobile telephone protocols to communicate with mobile devices 26.

Each network system 72 includes a network gateway 76 (e.g., 76-1, 76-2). The network gateway 76 (e.g., 76-1 and 76-2) is any suitable computing device or digital processing device that may serve as a gateway to the network system 72 in the heterogenous networked environment 70. Such a network gateway 76 can be a server, a router, a bridge, a switch or other network communications or computing device. In one embodiment, the network gateway 76-1 includes a digital processor 50-3, and the network gateway 76-2 includes a digital processor 50-4. Each digital processor, 50-3 or 50-4, hosts and executes a preferred embodiment of a gateway application 52-3 or 52-4 that serves as a gateway for each network system 72-1, 72-2. For example, the gateway application 52-3 provides access control (e.g., authentication and authorization) for the mobile device 26-16 communicating through the wireless network 90 to the network system 72-1. When the network gateway 76-1 or 76-2 is referred to herein as performing some function, this means that the digital processor 50-3 or 50-4 of each network gateway 76-1 or 76-2 is performing that function based on the instructions of each gateway application 52-3 or 52-4 that is hosted and executing on each digital processor 50-3 or 50-4.

Each network gateway 76 (e.g., 76-1, 76-2) also includes a communications interface 55 (e.g., 55-3, 55-4) that includes hardware and software that provides communications over network or other connections (wireless or hard wired) (e.g., wireless networks 90, 92, or intermediary network 74) to other entities (e.g., mobile devices 26, one or more authentication servers 78, or network systems 72).

One example of a network gateway 76 is the gateway server 40 (e.g., 40-1, 40-2) shown in FIG. 1. In another example, the network gateway 76 is the gateway system 22 (including both servers 40-1, 40-2) of FIG. 1. That is, in the gateway system 22, the functions of the network gateway 76 are performed by two or more servers 40.

In one embodiment, an authentication server 78 (a network computing device or network server) provides one or more of the access control functions in coordination with the network gateway 76 (e.g., 76-1, 76-2), in a similar manner to what was described previously for the authentication server 78 for FIG. 1. For example, the authentication server 78 can also provide network address services, such as IP addresses and DHCP services. In another embodiment, some or all of these services can be provided by the network gateway 76 (e.g., 76-1, 76-2), or through the coordinated functioning of the network gateway 76 (e.g., 76-1, 76-2) and the authentication server 78.

An intermediary network 74 connects the authentication server 78, network system 72-1, and network system 72-2. In one embodiment, the intermediary network 74 is a packet-based network, such as one based on the TCP/IP protocols. In other embodiments, the intermediary network 74 is a WAN (wide area network) link, satellite connection or network, frame relay connection, PSTN (public switched telephone network), or virtual circuits (virtual connections or pathways that may rely on various underlying lower level physical or media connections). The intermediary network 74 provides the connections and handshakes between the network systems 76-1 and 76-2 so that the mobile device 26-16 can perform a device transfer 88 to seamlessly transfer from one network system 76-1 to another 76-2. The protected network 36 and general access network 38 (of FIG. 1) are examples of intermediary networks 74, if, for example, these networks 36, 38 provide a connection from the gateway system 22 of FIG. 1 (which serves as a network system 72) to another network system 72 through one or both of the networks 36, 38.

A wireless network 90 provides communications for the network system 72-1 to the mobile device 26-16, when the mobile device 26-16 is associated with the network system 72-1 (i.e., before the device transfer 88 of the mobile device 26-16 to the network system 72-2). A wireless network 92 provides communications for the network system 72-2 to the mobile device 26-16, when the mobile device 26-16 is associated with the network system 72-2 (i.e., after the device transfer 88). The wireless networks 90, 92 are based on any suitable wireless communications protocols, such as WLAN wireless technologies (e.g., Bluetooth, or IEEE 802.11) or mobile telephone communication technologies (e.g., CMTS, GSM, PCS, or UMTS). The wireless networks 90 and 92 are heterogenous; that is, that do not use the same communications protocol or standard, and do not typically allow (or readily allow) for the transfer of mobile devices between the wireless networks 90, 92. For example, wireless network 90 is a Bluetooth WLAN and wireless network 92 is a UMTS system, or vice versa.

The mobile device 26-16 includes communications interfaces (e.g., communications hardware and software) that allow the mobile device 26-16 to communicate with two (or more) heterogenous wireless networks 90, 92. Thus, the mobile device 26-16 is capable of transferring (or moving) from one heterogenous wireless network 90 to another heterogenous wireless network 92. However, in a traditional approach, the mobile device 26-16 must establish a new connection and new communication session when moving between wireless networks 90,92.

The wireless connection 83 provides an association for the mobile device 26-16 with the network systems 72-1 or 72-2 through a connection that is suitable 83 (e.g., 83-1 or 83-2) for the wireless communications protocol supported by the respective network system 72-1 or 72-2.

The request 80 is a signal, message, network packet, or other communication from one (initial) network system (e.g., 72-1) to the other (target) network system (e.g., 72-2) that requests an access identifier 84 to be provided to the mobile device 26-16 that the mobile device 26-16 uses when first accessing the other network system (e.g., 72-2) during the device transfer 88. The request 80 indicates that the mobile device 26-16 is transferring (or likely to transfer) to the target network system 72-2. In one embodiment, the request 80 includes information about the mobile device 26-16 (e.g., device identification or address), the user of the mobile device 26-16 (e.g., user identification), a home network gateway (e.g., 76-1), a home network system (e.g., 72-1), authentication information (e.g., address of authentication server 78 to use for the mobile device 26-16 or its user), and/or any other information that may be useful to the target network gateway 76-2 in identifying and authenticating the mobile device 26-16

The response 82 is a signal, message, network packet, or other communication from one network system (e.g., 72-2) to the other (e.g., 72-1) that provides the access identifier 84. The access identifier 84 is a unique identifier (e.g., network address, IP address, MAC address, cookie, digital certificate, or other identifier) that identifies the mobile device 26-16 to the target network system (e.g., 72-2).

The present invention does not require that all of the request messages 80 and response messages 82 be completed, if not required. For example, if one network gateway 76-1 does not use the authentication server 78 for access control and network address services, but uses the other network gateway 76-2 for these services, the present invention does not require that the request 80 also be made to the authentication server 78 and that a response 82 be returned from the authentication server 78. In another example, if the network gateway 76-1 does use the authentication server 78 for access control and network address services, and does not use the other network gateway 76-2 for these services, the present invention does not require that the request 80 also be made to the network gateway 76-2 and that a response 82 be returned from the network gateway 76-2.

The internetwork tunnel 86 is a tunnel connection between the network gateway 76-2 and the network gateway 76-1 formed after the device transfer 88 so that the mobile device 26-16 continues to communicate in a seamless manner with the network gateway 76-1 that the mobile device 26-16 was communicating with before the device transfer 88. The internetwork tunnel 86 is a virtual connection that may be based on a direct physical connection (e.g., cable) between the network systems 72-1, 72-2, or based on a communications through the intermediary network 74.

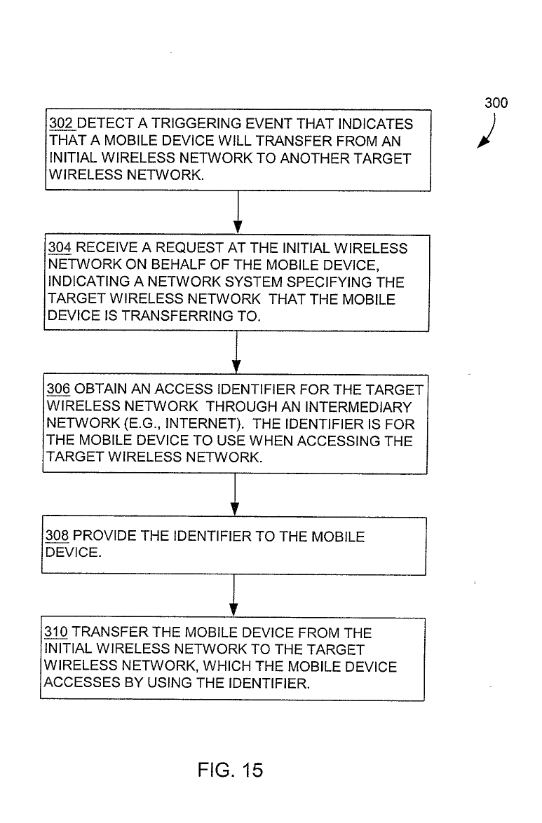

FIG. 15 is a flow chart of a procedure 300 for providing an access identifier 84 to a mobile device 26-16 to enable the device transfer 88 of FIG. 14 from an initial wireless network 90 to a target wireless network 92.

In step 302, the network gateway 76-1 detects a triggering event that indicates that a mobile device 26-16 will be transferring (or should transfer) from the initial wireless network 90 to the target wireless network 92. In one example, the triggering event is the movement of the mobile device 26-16 (as the user moves the device 26-16) out of range of the initial wireless network 90 and into range of the target wireless network 92 or some other triggering event as described previously for FIG. 3. For example, the mobile device 26-16 is a PDA with voice communication capabilities, and the user of the PDA 26-16 is moving the device 26-16 from a WLAN (e.g., 90) to a mobile telecommunications network (e.g., 92). The gateway server 76-1 can determine from a decreasing signal strength from the PDA 26-16 that the mobile device 26-16 is moving out of range of the WLAN (e.g., 90), and also determine that the mobile device 26-16 is likely to transfer to the target wireless network 92 (e.g., from a signal from the mobile device 26-16 indicating that it has detected that it is moving within range of the target wireless network 92).

Alternatively, the triggering event occurs when the mobile device 26-16 registers with the network gateway 76-1, and the network gateway 76-1 determines that the mobile device 26-16 is also capable of accessing another network system 72-2 (e.g., when the network gateway 76-1 receives this information from the authentication server 78). Then, the network gateway 76-1 anticipates that the mobile device 26-16 may try to access the other network system 72-2, and this anticipation by the network gateway 76-1 serves as the triggering event to trigger the request 80 (see step 304).

In step 304, the gateway application 52-3 of the network gateway 76-1 receives the request 80 through the communication interface 55-3 and the initial wireless network 90 on behalf of the mobile device 26-16. The request 80 indicates a network system 72-2 that specifies the target wireless network 92 that the mobile device 26-16 is transferring to (or anticipates transferring to). As described for step 302, the request 80 originates, for example, from the mobile device 26-16 as it moves out of range of the initial wireless network 90 and into range of the target wireless network 92. In another example, the request 80 originates with the network gateway 76-1 anticipating the transfer 88 of the mobile device 26-16 to another wireless network 92. The request 80 indicates another network system 72-2 that the mobile device 26-16 is transferring to. For example, the network system 72-2 is a mobile telephone network operated by a specific service provider, and the target wireless network 92 is the mobile phone network supported by this service provider.

In step 306, the gateway application 52-3 of the network gateway 76-1 obtains an access identifier 84 for the target wireless network 92 through the communications interface 55-3 and the intermediary network 74 (e.g., Internet). The network gateway 76-1 transfers the request 80 for the access identifier 84 from the network gateway 76-1 through the intermediary network 74 to the network gateway 76-2 of the target network system 72-2. For example, the network gateway 76-1 receives a request 80 from the mobile device 26-16 to transfer to the target wireless network 92 and repackages this request 80 as a request using a network protocol (e.g., IP) suitable for use over the intermediary network 74. The network gateway 72-2 (or authentication server 78) authenticates the mobile device 26-16 (and/or user of the mobile device 26-16) based on the information provided in the request 80. The network gateway 72-2 (or authentication server 78) returns a response 82 that contains the access identifier 84.

In step 308, the gateway application 52-3 of the network gateway 76-1 provides the response 82 to the mobile device 26-16 through the communications interface 55-3 and the initial wireless network 90. In one embodiment, the gateway application 52-3 stores the access identifier in a device database that includes data for mobile devices 26. For example, the device database is associated with a network gateway 76-1 (or network system 72-1 or intermediary network 74) and includes data for mobile device identification, access identifiers 84, and other data for one or more mobile devices 26 (e.g.,26-16).

In step 310, the network gateway 76-1 transfers the mobile device 26-16 from the initial wireless network 90 to the target wireless network 92, which the mobile device 26-16 accesses by using the newly received access identifier 84. Alternatively, the mobile device 26-16 transfers itself to the target wireless network 92 after it receives the access identifier 84. Thus, when the mobile device 26-16 makes the device transfer 88, the mobile device 26-16 can transfer seamlessly because the network gateway 76-2 rapidly identifies the mobile device 26-16 from the access identifier 84. The network gateway 76-2 sets up the tunnel 86 back to the home network gateway 76-1 for the mobile device 26-16 so that the mobile device 26-16 transfers seamlessly and does not experience any loss of connection or interruption in the current session (e.g. voice communication session) between the mobile device 26-16 and the home network gateway 76-1.

In one embodiment, the mobile device 26-16 stores the access identifier 84 for future use. That is, the mobile device 26-16 does not immediately perform the transfer 88 to the target wireless network 92, but keeps the access identifier 84 in anticipation of moving to another wireless network 92 at some point in the future.

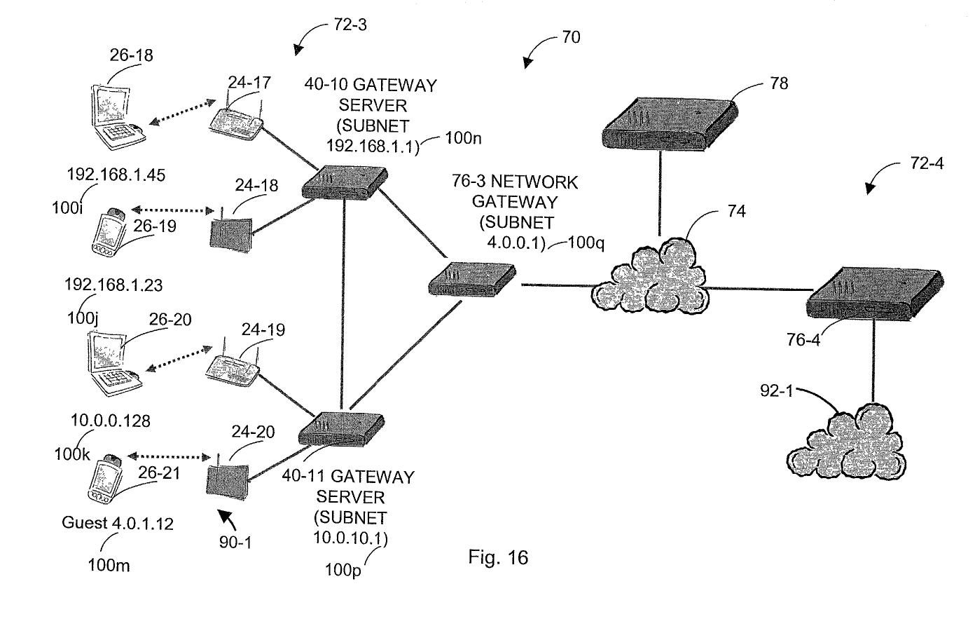

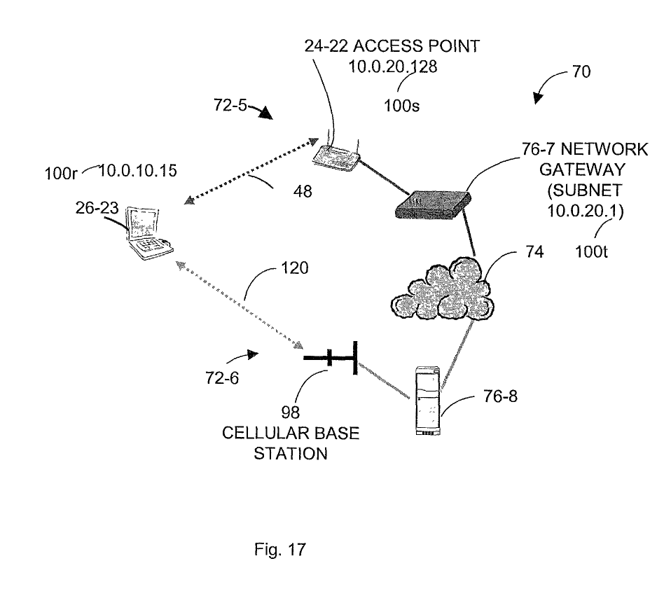

FIG. 16 illustrates heterogenous network environment 70 for a WLAN gateway 76-3 (for a WLAN network system 72-3) and a mobile telephone network gateway 76-4 (for a cellular network system 72-4), according to the present invention. The network environment 70 includes a common authentication server 78 (which may also provide IP address services), intermediary network 74, gateway servers 40-10, 40-11, access points 24-17 through 24-20, and mobile devices 26-18 through 26-21. The network addresses 100 may be based on IPv4 (Internet Protocol version 4) or IPv6 (Internet Protocol version 6). In the embodiments shown in FIGS. 16-21 the IP address 100 is one example of an access identifier 84. A mobile device 26 moves from the wide area cellular network system 72-4 (e.g., with network gateway 76-4) keeps its IPv4 address 100 and has its traffic tunneled back to the relevant gateway (e.g., 76-4) through an internetwork tunnel (e.g., 86) as in FIG. 14. The wireless data network gateway 76-3 acts as Foreign and Home Agent for mobile devices 26 that moves. A mobile station (e.g., mobile device) 26 registered with a cellular operator (e.g., through network gateway 76-4) can be assigned an IP address 100 by the common authentication server 78. (The mobile device 26 first receives a temporary IP address 100 from the network gateway 76-3 in order to authenticate. Then the IP address 100 is changed to that supplied by the authentication server 78 (with a very short DHCP time to live), in a manner similar to what was described for FIG. 7 and 8. FIGS. 17 through 21 illustrate further details of one example of the mobile device transfer process of the present invention.

In one embodiment, the configuration shown in FIG. 16 acts as an interface between the IPv4 and IPv6 network addressing protocols. For example, the network gateway 76-3 can act as an interface between the IPv4 and IPv6.

FIG. 17 is a schematic diagram illustrating heterogenous a network environment 70 with two heterogenous network systems 72-5, 72-6 and a mobile device 26-23, according to the present invention. The WLAN network system 72-5 includes a network gateway 76-7 (e.g., Bluetooth, IEEE 802.11, or other WLAN wireless technology) and an access point 24-22. The cellular network system 72-6 (e.g., mobile telephone cellular network) includes a cellular network gateway 76-8 and cellular base station 98. In one embodiment, the cellular network gateway 76-8 is a GGSN (Gateway GPRS Support Node) Internet gateway supporting 2.5G or 3G mobile telephone communication technology (e.g., UMTS). The intermediary network 74 (e.g., Internet) provides communications to the network gateways 76-7 and 76-8. The mobile device 26-23 can connect to the access point 24-22 through a WLAN wireless connection 48 or to the cellular base station 98 through a cellular wireless connection 120 suitable for a cellular mobile telephone connection. The wireless connection 48 and 120 are examples of the wireless connection 83 of FIG. 14.

The mobile device 26-23 such as a laptop computer, can have multiple radio interfaces such as both WLAN (e.g., Bluetooth, IEEE 802.11, or other WLAN wireless technology) and mobile telephone communication technology (e.g., 2.5G or 3G). These multiple radio interfaces can either be built into a single PCMCIA (Personal Computer Memory Card International Association) card or be two separate interface units (PCMCIA card and cellular telephone interface). In the later case, an operating system, such as the Microsoft® Windows® 2000 or XP operating system hosted and executing on a microprocessor in the mobile device 26-23 (e.g., laptop computer), can dynamically select which interface to use.

WLAN to cellular roaming is the ability of the mobile device 26-23 to change its route to the Internet 74 from the WLAN network system 72-5 to the cellular network system 72-6 or visa-versa without changing the IP address 100r of the mobile device 26-23 and hiding the change in routing or pathway to the Internet 74 from the Internet part of the connection. The second constraint is not required if an IPv6 network protocol is in use.

To avoid any changes to the network gateway 76-8, the user of the mobile device 26-23 must authenticate first with the cellular network system 72-6 before using the WLAN network system 72-5. Authenticating first with the WLAN system 72-5 is possible but requires that software (e.g., gateway application 52) hosted and executing on a processor 50 in the network gateway 76-8 be adapted appropriately.

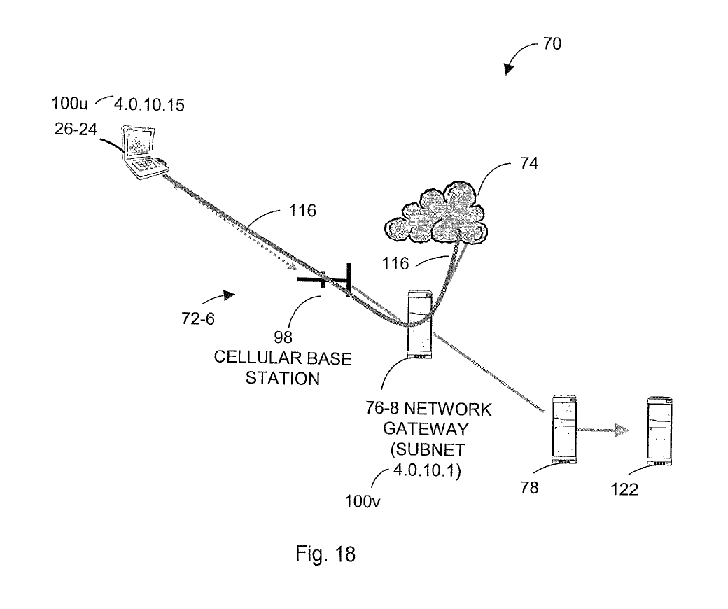

FIG. 18 is a schematic diagram illustrating a mobile device 26-24 connected to a cellular network system 72-6, according to the present invention. For example, when a mobile device 26-24 connects to an IPv4 cellular packet data network 72-6 then the mobile device 26-24 connects to the network gateway 76-8 (e.g., GGSN) via the cellular base station 98 and an SGSN (Serving GPRS Support Node). For the sake of simplicity this connection is treated herein as a connection to the network gateway 76-8 (e.g., serving the function of both SGSN & GGSN). The network gateway 76-8 authenticates the user against an authentication server 78, and provides the mobile device 26-24 with an IP address 100u. The cellular network system 72-6 connects to an authentication server 78 and a billing system 122.

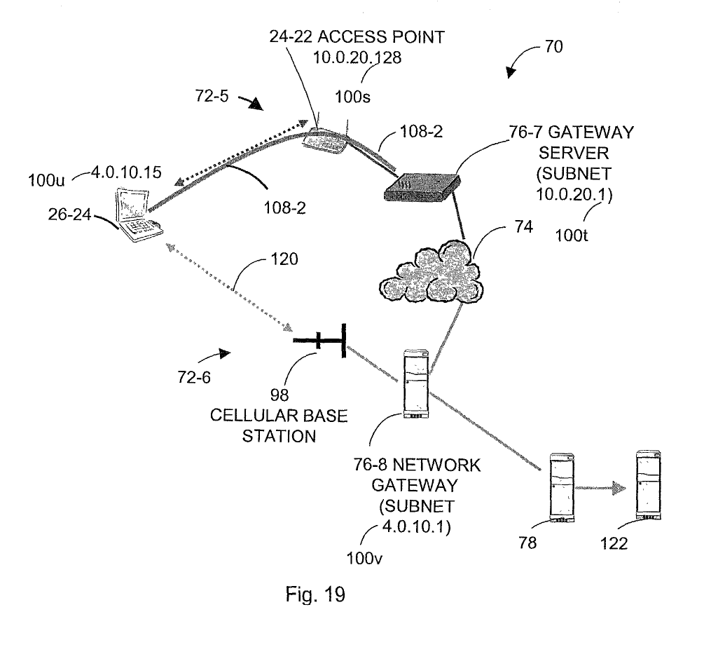

FIG. 19 is a schematic diagram illustrating an ARP request 108-2 for a mobile device 26-24 in a heterogenous network environment 70, according to the present invention. When the mobile device 26-24 moves from the cellular network system 72-6 into the coverage area of a WLAN network system 72-5, then the mobile device 26-24 detects the availability of the WLAN network system 72-5 and tries to connect (e.g., associate with access point 24-22 and WLAN network gateway 76-7). Some other triggering event (as described for FIG. 3) may also initiate the transfer of the mobile device 26-24 from the cellular network system 72-6 to the WLAN network system 72-5. The mobile device 26-24 sends data-packets to the MAC address of the network gateway 76-8 that the mobile device 26-24 had been using previously. Because the mobile device 26-24 no longer has a connection 120 to the cellular base station 98 (e.g., has moved out of range), there is no reply, so the mobile device 26-24 makes an ARP broadcast 108-2 with an IP address 100v having a value of 4.0.10.1 (which is the IP address 100v of the network gateway 76-8).

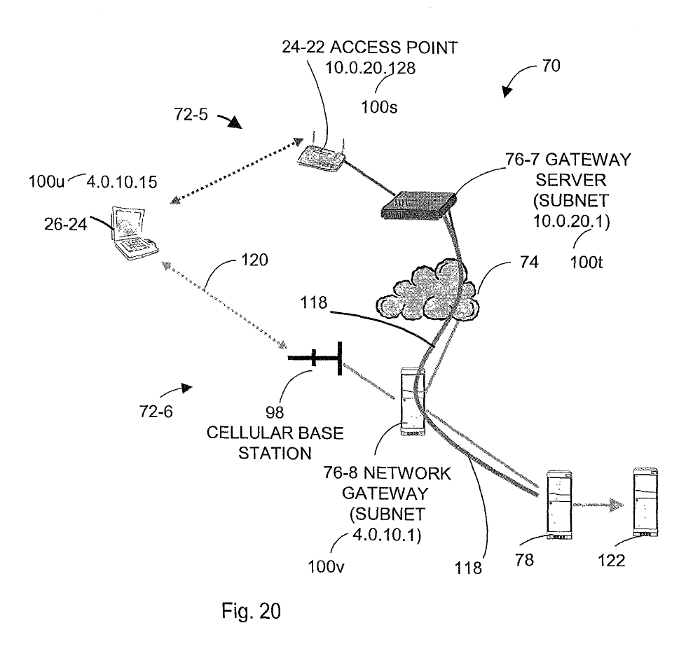

Before authenticating the mobile device 26-24, the network gateway 76-7 on the local subnet of the WLAN network system 72-5 responds to the ARP request 108-2 with the MAC address of the network gateway 76-7, so that the network gateway 76-7 becomes the gateway for the mobile device 26-24. The mobile device 26-24 still must be authenticated (see FIG. 20).

FIG. 20 is a schematic diagram illustrating an authentication query 118 for the mobile device 26-24 in the heterogenous network environment 70 of FIG. 19. After the gateway server 76-7 detects the arrival of the new mobile device 26-24, the gateway server 76-7 sends a query 118 to the authentication server 78 for the cellular network system 72-6. The authentication server 78 then confirms that the mobile device 26-24 had already been authenticated by the cellular network system 72-6, and provides the IP address 100v (e.g., 4.0.10.1) of the home network gateway 76-8 for the mobile device 26-24.

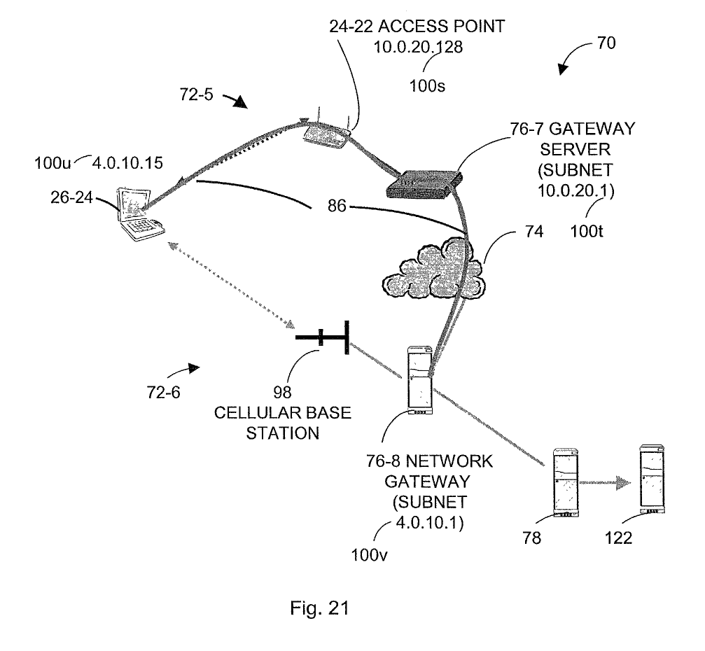

FIG. 21 is a schematic diagram illustrating an internetwork tunnel 86 for the mobile device 26-24 in the heterogenous network environment 70 of FIG. 19. After the network gateway 76-7 has obtained the IP address 100v of the home network gateway 76-8 for the mobile device 26-24, the network gateway 76-7, in one embodiment, sets up the internetwork tunnel 86 back to the network gateway 76-8 by emulating a cellular network gateway (e.g., GGSN interface) interface in the network gateway 76-7. In another embodiment, the network gateway 76-7 emulates an SGSN interface.

The current session that the mobile device 26-24 was conducting when connected to the cellular base station 98 then can continue without interruption or requiring the establishment of a new session with the network gateway 76-8. No changes are required to the cellular network gateway 76-8, because the network gateway 76-7 emulates the cellular network gateway (e.g., GGSN interface) using known tunneling protocols (e.g., inter GGSN tunneling protocols that are part of the 3G protocol).

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for enabling a mobile device to roam among access points in a wireless local area network, the mobile device capable of communicating with the access points, the method comprising the computer-implemented steps of:
establishing a secure connection from the mobile device through an initial access point to an initial gateway server;
providing connection information to a target gateway server from the initial gateway server about the secure connection, based on a triggering event that initiates a transfer of the mobile device from the initial access point to a target access point associated with the target gateway server; and
receiving the connection information at the target gateway server to maintain the secure connection from the mobile device through the target access point back to the initial gateway server.

2. The method of claim 1, wherein the mobile device is assigned an internet protocol address by the initial gateway server and the secure connection is based on the internet protocol address, and the step of providing the connection information includes maintaining the secure connection based on the internet protocol address assigned to the mobile device.

3. The method of claim 1, further comprising a step of providing a nested tunnel to couple the initial gateway server and the target gateway server.

4. The method of claim 3, wherein the step of providing the nested tunnel to couple the initial gateway server and the target gateway server is based on a hardwired connection between the initial gateway server and the target gateway server.

5. The method of claim 1, wherein the triggering event is a movement of the mobile device out of range of the initial access point and within range of the target access point.

6. The method of claim 1, wherein the triggering event is a determination that the target access point has a preferable level of congestion compared to a level of congestion for the initial access point.

7. The method of claim 1, wherein the step of providing the connection information comprises extending the secure connection from the target gateway server to the initial gateway server, so that the initial gateway server decrypts secure messages originating from the mobile device.

8. The method of claim 1, wherein the step of providing the connection information comprises establishing a virtual representation of the initial gateway server at the target gateway server.

9. A gateway system for enabling a mobile device to roam among access points in a wireless local area network, the mobile device capable of communicating with the access points, the gateway system comprising:
an initial gateway server, and
a target gateway server in communication with the initial gateway server; wherein:
the initial gateway server establishes a secure connection from the mobile device through an initial access;
the initial gateway server provides connection information to the target gateway server about the secure connection, based on a triggering event that initiates a transfer of the mobile device from the initial access point to a target access point associated with the target gateway server; and
the target gateway server receives the connection information to maintain the secure connection from the mobile device through the target access point back to the initial gateway server.

10. The gateway system of claim 9, wherein the mobile device is assigned an internet protocol address by the initial gateway server, the secure connection is based on the internet protocol address, and the initial gateway server maintains the connection based on the internet protocol address assigned to the mobile device.

11. The gateway system of claim 9, wherein the initial gateway server and the target gateway server are coupled by a nested tunnel between the initial gateway server and the target gateway server.

12. The gateway system of claim 11, wherein the nested tunnel between the initial gateway server and the target gateway server is based on a hard wired connection between the initial gateway server and the target gateway server.

13. The gateway system of claim 9, wherein the triggering event is a movement of the mobile device out of range of the initial access point and within range of the target access point.

14. The gateway system of claim 9, wherein the triggering event is a determination that the target access point has a preferable level of congestion compared to a level of congestion for the initial access point.

15. The gateway system of claim 9, wherein the target gateway server extends the secure connection from the target gateway server to the initial gateway server, so that the initial gateway server decrypts secure messages originating from the mobile device.

16. The gateway system of claim 9, wherein the target gateway server establishes a virtual representation of the initial gateway server at the target gateway server.

17. A computer program product that includes a computer usable medium having computer program instructions stored thereon for enabling a mobile device to roam among access points in a wireless local area network, the mobile device capable of communicating with the access points, such that the computer program instructions, when performed by a digital processor, cause the digital processor to:
establish a secure connection from the mobile device through an initial access point to an initial gateway server;
provide connection information to a target gateway server from the initial gateway server about the secure connection, based on a triggering event that initiates a transfer of the mobile device from the initial access point to a target access point associated with the target gateway server; and
receive the connection information at the target gateway server to maintain the secure connection from the mobile device through the target access point back to the initial gateway server.

18. A method for enabling a mobile device to roam between a first wireless network and a second wireless network, the first wireless network substantially heterogeneous with the second wireless network, both the first wireless network and the second wireless network capable of communicating with an intermediary network, and the mobile device capable of accessing the first wireless network and the second wireless network, the method comprising the computer-implemented steps of:
receiving a request at the first wireless network to access the second wireless network, the request being on behalf of the mobile device and indicating a network system specifying the second wireless network;
through the intermediary network, obtaining an access identifier for the second wireless network, the access identifier for use by the mobile device when accessing the second wireless network; and
providing the access identifier for the mobile device to use when accessing the second wireless network.

19. The method of claim 18, wherein the first wireless network is a wireless local area network, the second wireless network is a cellular telecommunications network, and the mobile device is a personal digital assistant.

20. The method of claim 18, wherein the request includes a user identification of a user of the mobile device, and the step of receiving the request includes determining an identity of the network system as a function of the user identification.

21. The method of claim 18, wherein the step of obtaining the access identifier includes providing an authentication request based on the request to a dynamic host configuration server.

22. The method of claim 18, wherein the access identifier is an internet protocol address and the intermediary network is the internet.

23. The method of claim 18, wherein the step of obtaining the access identifier includes requesting the access identifier from a network gateway for the second wireless network, the network gateway providing the access identifier from a predefined range of access identifiers allocated to the second wireless network.

24. The method of claim 18, wherein the step of providing the access identifier includes storing the access identifier in a device database that includes a device identification for the mobile device.

25. A network gateway for enabling a mobile device to roam between a first wireless network and a second wireless network, the first wireless network substantially heterogeneous with the second wireless network, both the first wireless network and the second wireless network capable of communicating with an intermediary network, and the mobile device capable of accessing the first wireless network and the second wireless network, the network gateway comprising:
a digital processor that hosts and executes a gateway application for receiving a request to access the second wireless network, the gateway application and the mobile device associated with the first wireless network, and
a communications interface coupled with the gateway application, the gateway application configuring the digital processor to:
receive the request through the communication interface and the initial wireless network to access the second wireless network, the request being on behalf of the mobile device and indicating a network system specifying the second wireless network;
obtain through the communications interface and the intermediary network an access identifier for the second wireless network, the access identifier for use by the mobile device when accessing the second wireless network, and
provide through the communications interface the access identifier to the mobile device to use when accessing the second wireless network.

26. The network gateway of claim 25, wherein the first wireless network is a wireless local area network, the second wireless network is a cellular telecommunications network, and the mobile device is a personal digital assistant.

27. The network gateway of claim 25, wherein the request includes a user identification of a user of the mobile device, and the gateway application configures the digital processor to determine an identity of the network system as a function of the user identification.

28. The network gateway of claim 25, wherein the gateway application configures the digital processor to provide through the communications interface an authentication request based on the request to a dynamic host configuration server.

29. The network gateway of claim 25, wherein the access identifier is an internet protocol address and the intermediary network is the internet.

30. The network gateway of claim 25, wherein the gateway application configures the digital processor to request through the communications interface the access identifier from a second network gateway for the second wireless network, the second network gateway providing the access identifier from a predefined range of access identifiers allocated to the second wireless network.

31. The network gateway of claim 25, wherein the gateway application configures the digital processor to store the access identifier in a device database that includes a device identification for the mobile device.

32. A computer program product that includes a computer usable medium having computer program instructions stored thereon for enabling a mobile device to roam between a first wireless network and a second wireless network, the first wireless network substantially heterogeneous with the second wireless network, both the first wireless network and the second wireless network capable of communicating with an intermediary network, and the mobile device capable of accessing the first wireless network and the second wireless network, such that the computer program instructions, when performed by a digital processor, cause the digital processor to:
receive a request at the first wireless network to access the second wireless network, the request being on behalf of the mobile device and indicating a network system specifying the second wireless network;
through the intermediary network, obtain an access identifier for the second wireless network, the access identifier for use by the mobile device when accessing the second wireless network; and
provide the access identifier to the mobile device to use when accessing the second wireless network.
